(19) United States
(12) Patent Application Publication
(10) Pub. No.: US 2026/0122723 A1
(43) Pub. Date: Apr. 30, 2026

(54) METHOD AND DEVICE FOR TRANSMITTING AND RECEIVING WIRELESS SIGNAL IN WIRELESS COMMUNICATION SYSTEM

(71) Applicant: LG ELECTRONICS INC., Seoul (KR)

(72) Inventors: Seunggye HWANG, Seoul (KR); Jaehyung KIM, Seoul (KR); Youngdae LEE, Seoul (KR); Suckchel YANG, Seoul (KR)

(73) Assignee: LG ELECTRONICS INC., Seoul (KR)

(21) Appl. No.: 18/846,141

(22) PCT Filed: Mar. 30, 2023
(86) PCT No.: PCT/KR2023/004234

§ 371 Date: Sep. 11, 2024

(30) Foreign Application Priority Data
Apr. 28, 2022 (KR) 10-2022-0052938

(51) Int. Cl. H04W 76/28; H04W 8/24; H04W 72/23

(52) U.S. Cl. CPC H04W 76/28; H04W 8/24; H04W 72/23

(57) ABSTRACT

According to at least one of the examples disclosed in the present specification, a terminal receives DRX configuration information including information on a discontinuous reception (DRX) cycle and monitors a physical downlink control channel (PDCCH) on the basis of the DRX configuration information, wherein an on-duration set is configured for each DRX cycle, each on-duration set including a plurality of on-durations which are spaced apart from each other on a time axis and on the basis of which the terminal may monitor the PDCCH.

### TECHNICAL FIELD

The disclosure relates to a wireless communication system, and more particularly, to a method and apparatus for transmitting and receiving a wireless signal.

### BACKGROUND ART

Generally, a wireless communication system is developing to diversely cover a wide range to provide such a communication service as an audio communication service, a data communication service and the like. The wireless communication is a sort of a multiple access system capable of supporting communications with multiple users by sharing available system resources (e.g., bandwidth, transmit power, etc.). For example, the multiple access system may be any of a code division multiple access (CDMA) system, a frequency division multiple access (FDMA) system, a time division multiple access (TDMA) system, an orthogonal frequency division multiple access (OFDMA) system, and a single carrier frequency division multiple access (SC-FDMA) system.

### DISCLOSURE

### Technical Problem

An object of the disclosure is to provide a method of efficiently performing wireless signal transmission/reception procedures and an apparatus therefor.

It will be appreciated by persons skilled in the art that the objects that could be achieved with the disclosure are not limited to what has been particularly described hereinabove and the above and other objects that the disclosure could achieve will be more clearly understood from the following detailed description.

### Technical Solution

A method of receiving a signal by a user equipment (UE) in a wireless communication system according to an aspect of the disclosure includes receiving discontinuous reception (DRX) configuration information including information about a DRX cycle, and monitoring a physical downlink control channel (PDCCH) based on the DRX configuration information. Each On-duration set including a plurality of On-durations spaced apart from each other on a time axis is configured in each DRX cycle. The UE monitors the PDCCH based on the plurality of On-durations included in each On-duration set. Based on the PDCCH being detected in any one of the plurality of On-durations as a result of monitoring the PDCCH, the UE determines that no subsequent On-duration will occur until a start of a next DRX cycle.

The UE may be configured with at least one of first information about a maximum time duration in which each On-duration set is maintained to be valid from a start of each On-duration set or second information about a maximum number of valid On-durations included in each On-duration set. The DRX configuration information may include at least one of the first information or the second information.

Based on the PDCCH being detected in an On-duration located before the maximum time duration or the maximum number of On-durations is reached, the On-duration set may be early terminated.

Data scheduled by the detected PDCCH may have a non-integer periodicity.

The DRX configuration information may include at least one of information about a gap between the plurality of On-durations or information about a position of a starting On-duration among the plurality of On-durations. The information about the gap between the plurality of On-durations may include a periodicity of the plurality of On-durations. The information about the position of the starting On-duration may include an offset between the start of the DRX cycle and the start of the starting On-duration.

A length of each On-duration may be individually configured in a same On-duration set.

According to another aspect of the disclosure, a processor-readable recoding medium recording a program for performing the above-described signal reception method may be provided.

According to another aspect of the disclosure, a UE for performing the above-described signal reception method may be provided.

According to another aspect of the disclosure, a device for controlling a UE performing the above-described signal reception method may be provided.

According to another aspect of the disclosure, a method of transmitting a signal by a base station (BS) in a wireless communication system includes transmitting DRX configuration information including information about a DRX cycle to a UE, and transmitting a PDCCH to the UE based on the DRX configuration information. Each On-duration set including a plurality of On-durations spaced apart from each other on a time axis is configured in each DRX cycle. The BS transmits the PDCCH based on the plurality of On-durations included in each On-duration set. Based on the PDCCH being transmitted in any one of the plurality of On-durations, the BS determines that a subsequent On-duration for the UE will not occur until a start of a next DRX cycle.

According to another aspect of the disclosure, a BS for performing the above-described signal transmission method may be provided.

### Advantageous Effects

According to an embodiment of the disclosure, as signal transmission and reception are performed based on an improved DRX operation, power efficiency may be increased.

It will be appreciated by persons skilled in the art that the effects that may be achieved with the disclosure are not limited to what has been particularly described hereinabove and other advantages of the disclosure will be more clearly understood from the following detailed description taken in conjunction with the accompanying drawings.

### DESCRIPTION OF DRAWINGS

FIG. 1 illustrates physical channels used in a 3^{rd} generation partnership project (3GPP) system as an exemplary wireless communication system, and a general signal transmission method using the same.

FIG. 2 illustrates a radio frame structure.

FIG. 3 illustrates a resource grid of a slot.

FIG. 4 illustrates exemplary mapping of physical channels in a slot.

FIG. 5 illustrates an exemplary physical downlink control channel (PDCCH) transmission and reception process.

FIG. 6 illustrates an exemplary physical downlink shared channel (PDSCH) reception and acknowledgement/negative acknowledgement (ACK/NACK) transmission process.

FIG. 7 illustrates an exemplary physical uplink shared channel (PUSCH) transmission process.

FIGS. 8 to 10 are diagrams for explaining discontinuous reception (DRX) related operations.

FIG. 11 illustrates an exemplary On-duration burst.

FIG. 12 illustrates an exemplary user equipment (UE) operation.

FIG. 13 illustrates an exemplary base station (BS) operation.

FIG. 14 illustrates an exemplary maximum length of an On-duration burst and an exemplary maximum number of On-durations.

FIG. 15 illustrates an exemplary UE operation.

FIG. 16 illustrates an exemplary BS operation.

FIG. 17 illustrates exemplary termination of an On-duration burst.

FIG. 18 illustrates an exemplary UE operation.

FIG. 19 illustrates an exemplary BS operation.

FIG. 20 illustrates an example of the positions of On-durations.

FIG. 21 illustrates an exemplary UE operation.

FIG. 22 illustrates an exemplary BS operation.

FIGS. 23 to 26 illustrate various examples of On-durations.

FIG. 27 is a flowchart illustrating a method of receiving a signal at a UE according to an embodiment.

FIG. 28 is a flowchart illustrating a method of transmitting a signal at a BS according to an embodiment.

FIGS. 29 to 32 illustrate an example of a communication system 1 and wireless devices applicable to the disclosure.

### MODE FOR DISCLOSURE

Embodiments of the disclosure are applicable to a variety of wireless access technologies such as code division multiple access (CDMA), frequency division multiple access (FDMA), time division multiple access (TDMA), orthogonal frequency division multiple access (OFDMA), and single carrier frequency division multiple access (SC-FDMA). CDMA may be implemented as a radio technology such as Universal Terrestrial Radio Access (UTRA) or CDMA2000. TDMA may be implemented as a radio technology such as Global System for Mobile communications (GSM)/General Packet Radio Service (GPRS)/Enhanced Data Rates for GSM Evolution (EDGE). OFDMA may be implemented as a radio technology such as Institute of Electrical and Electronics Engineers (IEEE) 802.11 (Wireless Fidelity (Wi-Fi)), IEEE 802.16 (Worldwide interoperability for Microwave Access (WiMAX)), IEEE 802.20, and Evolved UTRA (E-UTRA). UTRA is a part of Universal Mobile Telecommunications System (UMTS). 3rd Generation Partnership Project (3GPP) Long Term Evolution (LTE) is part of Evolved UMTS (E-UMTS) using E-UTRA, and LTE-Advanced (A) is an evolved version of 3GPP LTE. 3GPP NR (New Radio or New Radio Access Technology) is an evolved version of 3GPP LTE/LTE-A.

As more and more communication devices require a larger communication capacity, there is a need for mobile broadband communication enhanced over conventional radio access technology (RAT). In addition, massive Machine Type Communications (MTC) capable of providing a variety of services anywhere and anytime by connecting multiple devices and objects is another important issue to be considered for next generation communications. Communication system design considering services/UEs sensitive to reliability and latency is also under discussion. As such, introduction of new radio access technology considering enhanced mobile broadband communication (eMBB), massive MTC, and Ultra-Reliable and Low Latency Communication (URLLC) is being discussed. In an embodiment of the disclosure, for simplicity, this technology will be referred to as NR (New Radio or New RAT).

For the sake of clarity, 3GPP NR is mainly described, but the technical idea of the disclosure is not limited thereto.

For the background art relevant to the disclosure, the definitions of terms, and abbreviations, the following documents may be incorporated by reference.

### 3GPP LTE

TS 36.211: Physical channels and modulation
TS 36.212: Multiplexing and channel coding
TS 36.213: Physical layer procedures
TS 36.300: Overall description
TS 36.321: Medium Access Control (MAC)
TS 36.331: Radio Resource Control (RRC)

### 3GPP NR

TS 38.211: Physical channels and modulation
TS 38.212: Multiplexing and channel coding
TS 38.213: Physical layer procedures for control
TS 38.214: Physical layer procedures for data
TS 38.300: NR and NG-RAN Overall Description
TS 38.304: User Equipment (UE) procedures in idle mode and in RRC Inactive state
TS 38.321: Medium Access Control (MAC)
TS 38.331: Radio Resource Control (RRC) protocol specification
TS 37.213: Introduction of channel access procedures to unlicensed spectrum for NR-based access

### Terms and Abbreviations

PSS: Primary Synchronization Signal
SSS: Secondary Synchronization Signal
CRS: Cell reference signal
CSI-RS: Channel State Information Reference Signal
TRS: Tracking Reference Signal
SS: Search Space
CSS: Common Search Space
USS: UE-specific Search Space
PDCCH: Physical Downlink Control Channel; The PDCCH is used to represent PDCCHs of various structures which may be used for the same purpose in the following description.
PO: Paging Occasion
MO: Monitoring Occasion
SI: System Information
PEI: Paging Early Indication
DRX: Discontinuous Reception
eDRX: Extended DRX

In a wireless communication system, a user equipment (UE) receives information through downlink (DL) from a base station (BS) and transmit information to the BS through uplink (UL). The information transmitted and received by the BS and the UE includes data and various control information and includes various physical channels according to type/usage of the information transmitted and received by the UE and the BS.

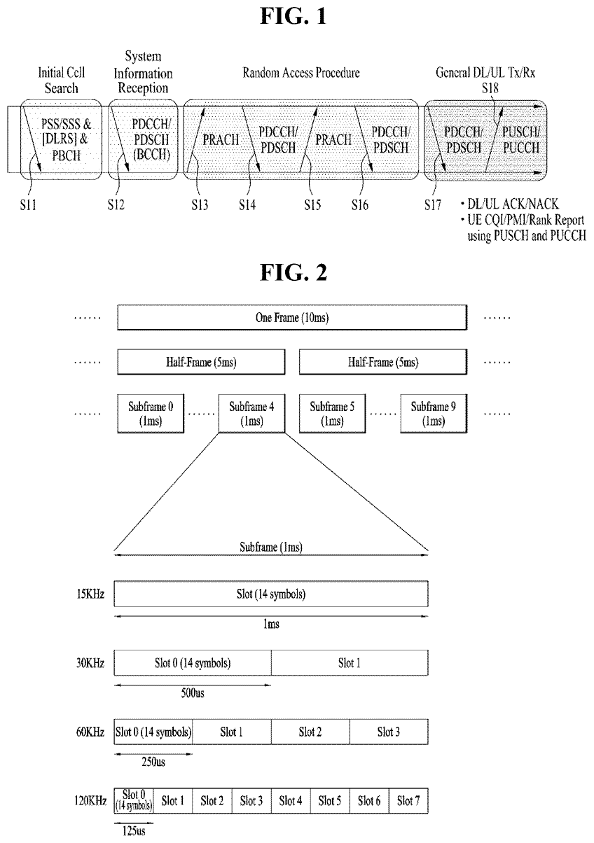

FIG. 1 illustrates physical channels used in a 3GPP NR system and a general signal transmission method using the same.

When a UE is powered on again from a power-off state or enters a new cell, the UE performs an initial cell search procedure, such as establishment of synchronization with a BS, in step S101. To this end, the UE receives a synchronization signal block (SSB) from the BS. The SSB includes a primary synchronization signal (PSS), a secondary synchronization signal (SSS), and a physical broadcast channel (PBCH). The UE establishes synchronization with the BS based on the PSS/SSS and acquires information such as a cell identity (ID). The UE may acquire broadcast information in a cell based on the PBCH. The UE may receive a DL reference signal (RS) in an initial cell search procedure to monitor a DL channel status.

After initial cell search, the UE may acquire more specific system information by receiving a physical downlink control channel (PDCCH) and receiving a physical downlink shared channel (PDSCH) based on information of the PDCCH in step S102.

The UE may perform a random access procedure to access the BS in steps S103 to S106. For random access, the UE may transmit a preamble to the BS on a physical random access channel (PRACH) (S103) and receive a response message for preamble on a PDCCH and a PDSCH corresponding to the PDCCH (S104). In the case of contention-based random access, the UE may perform a contention resolution procedure by further transmitting the PRACH (S105) and receiving a PDCCH and a PDSCH corresponding to the PDCCH (S106).

After the foregoing procedure, the UE may receive a PDCCH/PDSCH (S107) and transmit a physical uplink shared channel (PUSCH)/physical uplink control channel (PUCCH) (S108), as a general downlink/uplink signal transmission procedure. Control information transmitted from the UE to the BS is referred to as uplink control information (UCI). The UCI includes hybrid automatic repeat and request acknowledgement/negative-acknowledgement (HARQ-ACK/NACK), scheduling request (SR), channel state information (CSI), etc. The CSI includes a channel quality indicator (CQI), a precoding matrix indicator (PMI), a rank indicator (RI), etc. While the UCI is transmitted on a PUCCH in general, the UCI may be transmitted on a PUSCH when control information and traffic data need to be simultaneously transmitted. In addition, the UCI may be aperiodically transmitted through a PUSCH according to request/command of a network.

FIG. 2 illustrates a radio frame structure. In NR, uplink and downlink transmissions are configured with frames. Each radio frame has a length of 10 ms and is divided into two 5-ms half-frames (HF). Each half-frame is divided into five 1-ms subframes (SFs). A subframe is divided into one or more slots, and the number of slots in a subframe depends on subcarrier spacing (SCS). Each slot includes 12 or 14 Orthogonal Frequency Division Multiplexing (OFDM) symbols according to a cyclic prefix (CP). When a normal CP is used, each slot includes 14 OFDM symbols. When an extended CP is used, each slot includes 12 OFDM symbols.

Table 1 exemplarily shows that the number of symbols per slot, the number of slots per frame, and the number of slots per subframe vary according to the SCS when the normal CP is used.

TABLE 1

| SCS (15*2^{u}) | N^{slot}_{symb} | N^{frame, u}ₛₗₒₜ | N^{subframe, u}ₛₗₒₜ |
|---|---|---|---|
| 15 KHz (u = 0) | 14 | 10 | 1 |
| 30 KHz (u = 1) | 14 | 20 | 2 |
| 60 KHz (u = 2) | 14 | 40 | 4 |
| 120 KHz (u = 3) | 14 | 80 | 8 |
| 240 KHz (u = 4) | 14 | 160 | 16 |

N^{slot}_{symb}: Number of symbols in a slot
N^{frame, u}ₛₗₒₜ: Number of slots in a frame
N^{subframe, u}ₛₗₒₜ: Number of slots in a subframe

Table 2 illustrates that the number of symbols per slot, the number of slots per frame, and the number of slots per subframe vary according to the SCS when the extended CP is used.

TABLE 2

| SCS (15*2^{u}) | N^{slot}_{symb} | N^{frame, u}ₛₗₒₜ | N^{subframe, u}ₛₗₒₜ |
|---|---|---|---|
| 60 KHz (u = 2) | 12 | 40 | 4 |

The structure of the frame is merely an example. The number of subframes, the number of slots, and the number of symbols in a frame may vary.

In the NR system, OFDM numerology (e.g., SCS) may be configured differently for a plurality of cells aggregated for one UE. Accordingly, the (absolute time) duration of a time resource (e.g., an SF, a slot or a TTI) (for simplicity, referred to as a time unit (TU)) consisting of the same number of symbols may be configured differently among the aggregated cells. Here, the symbols may include an OFDM symbol (or a CP-OFDM symbol) and an SC-FDMA symbol (or a discrete Fourier transform-spread-OFDM (DFT-s-OFDM) symbol).

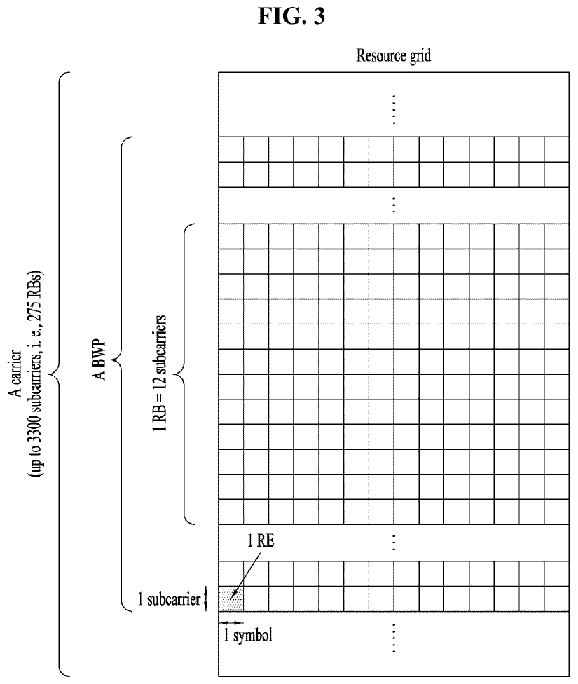

FIG. 3 illustrates a resource grid of a slot. A slot includes a plurality of symbols in the time domain. For example, when the normal CP is used, the slot includes 14 symbols. However, when the extended CP is used, the slot includes 12 symbols. A carrier includes a plurality of subcarriers in the frequency domain. A resource block (RB) is defined as a plurality of consecutive subcarriers (e.g., 12 consecutive subcarriers) in the frequency domain. A bandwidth part (BWP) may be defined to be a plurality of consecutive physical RBs (PRBs) in the frequency domain and correspond to a single numerology (e.g., SCS, CP length, etc.). The carrier may include up to N (e.g., 5) BWPs. Data communication may be performed through an activated BWP, and only one BWP may be activated for one UE. In the resource grid, each element is referred to as a resource element (RE), and one complex symbol may be mapped to each RE.

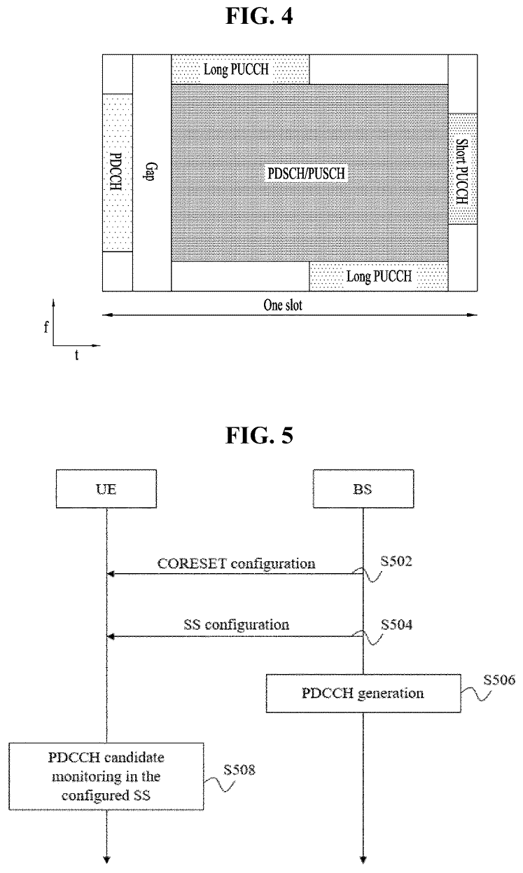

FIG. 4 illustrates an example of mapping physical channels in a slot. In an NR system, a frame is characterized by a self-contained structure in which all of a DL control channel, DL or UL data, and a UL channel may be included in one slot. For example, the first N symbols of a slot may be used to carry a DL channel (e.g., PDCCH) (hereinafter, referred to as a DL control region), and the last M symbols of the slot may be used to carry a UL channel (e.g., PUCCH) (hereinafter, referred to as a UL control region). Each of N and M is an integer equal to or larger than 0. A resource area (hereinafter, referred to as a data region) between the DL control region and the UL control region may be used to transmit DL data (e.g., PDSCH) or UL data (e.g., PUSCH). A guard period (GP) provides a time gap for switching from a transmission mode to a reception mode or from the reception mode to the transmission mode. Some symbols at a DL-to-UL switching time in a subframe may be configured as a GP.

The PDCCH delivers DCI. For example, the PDCCH (i.e., DCI) may carry information about a transport format and resource allocation of a DL shared channel (DL-SCH), resource allocation information of an uplink shared channel (UL-SCH), paging information on a paging channel (PCH), system information on the DL-SCH, information on resource allocation of a higher-layer control message such as an RAR transmitted on a PDSCH, a transmit power control command, information about activation/release of configured scheduling, and so on. The DCI includes a cyclic redundancy check (CRC). The CRC is masked with various identifiers (IDs) (e.g., a radio network temporary identifier (RNTI)) according to an owner or usage of the PDCCH. For example, if the PDCCH is for a specific UE, the CRC is masked by a UE ID (e.g., cell-RNTI (C-RNTI)). If the PDCCH is for a paging message, the CRC is masked by a paging-RNTI (P-RNTI). If the PDCCH is for system information (e.g., a system information block (SIB)), the CRC is masked by a system information RNTI (SI-RNTI). When the PDCCH is for an RAR, the CRC is masked by a random access-RNTI (RA-RNTI).

FIG. 5 illustrates an exemplary PDCCH transmission/reception process.

Referring to FIG. 5, a BS may transmit a control resource set (CORESET) configuration to a UE (S502). A CORESET is defined as a resource element group (REG) set having a given numerology (e.g., a subcarrier spacing (SCS), a cyclic prefix (CP) length, and so on). An REG is defined as one OFDM symbol by one (physical) resource block (P)RB. A plurality of CORESETs for one UE may overlap with each other in the time/frequency domain. A CORESET may be configured by system information (e.g., a master information block (MIB)) or higher-layer signaling (e.g., radio resource control (RRC) signaling). For example, configuration information about a specific common CORESET (e.g., CORESET #0) may be transmitted in the MIB. For example, a PDSCH carrying system information block 1 (SIB1) may be scheduled by a specific PDCCH, and CORESET #0 may be used to transmit the specific PDCCH. System information (SIB1) broadcast in a cell includes cell-specific PDSCH configuration information, PDSCH-ConfigCommon. PDSCH-ConfigCommon includes a list (or look-up table) of parameters related to a time-domain resource allocation, pdsch-TimeDomainAllocationList. Each pdsch-TimeDomainAllocationList may include up to 16 entries (or rows) each being joint-encoded {K0, PDSCH mapping type, PDSCH start symbol and length (SLIV)}. Aside from (additionally to) pdsch-TimeDomainAllocationList configured through PDSCH-ConfigCommon, pdsch-TimeDomainAllocationList may be provided through a UE-specific PDSCH configuration, PDSCH-Config. pdsch-TimeDomainAllocationList configured UE-specifically has the same structure as pdsch-TimeDomainAllocationList provided UE-commonly. For KG and an SLIV of pdsch-TimeDomainAllocationList, the following description is referred to.

Further, configuration information about CORESET #N (e.g., N>0) may be transmitted by RRC signaling (e.g., cell-common RRC signaling, UE-specific RRC signaling, or the like). For example, the UE-specific RRC signaling carrying CORESET configuration information may include, but not limited to, various types of signaling such as an RRC setup message, an RRC reconfiguration message, and/or BWP configuration information. Specifically, a CORESET configuration may include the following information/fields.
controlResourceSetId: Indicates the ID of a CORESET.
frequencyDomainResources: Indicates the frequency-domain resources of the CORESET. The resources are indicated by a bitmap in which each bit corresponds to an RB group (=6 (consecutive) RBs). For example, the most significant bit (MSB) of the bitmap corresponds to a first RB group in a BWP. An RB group corresponding to a bit having a bit value of 1 is allocated as frequency-domain resources of the CORESET.
duration: Indicates the time-domain resources of the CORESET. It indicates the number of consecutive OFDM symbols included in the CORESET. The duration has a value between 1 and 3.
cce-REG-MappingType: Indicates a control channel element (CCE)-to-REG mapping type. An interleaved type and a non-interleaved type are supported.
interleaverSize: Indicates an interleaver size.
pdcch-DMRS-ScramblingID: Indicates a value used for PDCCH DMRS initialization. When pdcch-DMRS-ScramblingID is not included, the physical cell ID of a serving cell is used.
precoderGranularity: Indicates a precoder granularity in the frequency domain.
reg-BundleSize: Indicates an REG bundle size.
tci-PresentInDCI: Indicates whether a transmission configuration index (TCI) field is included in DL-related DCI.
tci-StatesPDCCH-ToAddList: Indicates a subset of TCI states configured in pdcch-Config, used for providing quasi-co-location (QCL) relationships between DL RS(s) in an RS set (TCI-State) and PDCCH DMRS ports.

Further, the BS may transmit a PDCCH search space (SS) configuration to the UE (S504). The PDCCH SS configuration may be transmitted by higher layer signaling (e.g., RRC signaling). For example, the RRC signaling may include, but not limited to, various types of signaling such as an RRC setup message, an RRC reconfiguration message, and/or BWP configuration information. While a CORESET configuration and a PDCCH SS configuration are shown as separately signaled in FIG. 5, for convenience of description, the disclosure is not limited thereto. For example, the CORESET configuration and the PDCCH SS configuration may be transmitted in one message (e.g., by one RRC signaling) or separately in different messages.

The PDCCH SS configuration may include information about the configuration of a PDCCH SS set. The PDCCH SS set may be defined as a set of PDCCH candidates monitored (e.g., blind-detected) by the UE. One or more SS sets may be configured for the UE. Each SS set may be a UE-specific search space (USS) set or a common search space (CSS) set. For convenience, PDCCH SS set may be referred to as “SS” or “PDCCH SS.”

A PDCCH SS set includes PDCCH candidates. A PDCCH candidate is CCE(s) that the UE monitors to receive/detect a PDCCH. The monitoring includes blind decoding (BD) of PDCCH candidates. One PDCCH (candidate) includes 1, 2, 4, 8, or 16 CCEs according to an aggregation level (AL). One CCE includes 6 REGs. Each CORESET configuration is associated with one or more SSs, and each SS is associated with one CORESET configuration. One SS is defined based on one SS configuration, and the SS configuration may include the following information/fields.
searchSpaceId: Indicates the ID of an SS.
controlResourceSetId: Indicates a CORESET associated with the SS.
monitoringSlotPeriodicityAndOffset: Indicates a periodicity (in slots) and offset (in slots) for PDCCH monitoring.
monitoringSymbolsWithinSlot: Indicates the first OFDM symbol(s) for PDCCH monitoring in a slot configured with PDCCH monitoring. The first OFDM symbol(s) for PDCCH monitoring is indicated by a bitmap with each bit corresponding to an OFDM symbol in the slot. The MSB of the bitmap corresponds to the first OFDM symbol of the slot. OFDM symbol(s) corresponding to bit(s) set to 1 corresponds to the first symbol(s) of a CORESET in the slot.
nrofCandidates: Indicates the number of PDCCH candidates (one of values 0, 1, 2, 3, 4, 5, 6, and 8) for each AL where AL={1, 2, 4, 8, 16}.
searchSpaceType: Indicates CSS or USS as well as a DCI format used in the corresponding SS type.

Subsequently, the BS may generate a PDCCH and transmit the PDCCH to the UE (S506), and the UE may monitor PDCCH candidates in one or more SSs to receive/detect the PDCCH (S508). An occasion (e.g., time/frequency resources) in which the UE is to monitor PDCCH candidates is defined as a PDCCH (monitoring) occasion. One or more PDCCH (monitoring) occasions may be configured in a slot.

Table 3 shows the characteristics of each SS.

TABLE 3

| | Search | | |
|---|---|---|---|
| Type | Space | RNTI | Use Case |
| Type0- | Common | SI-RNTI on a primary cell | SIB |
| PDCCH | | | Decoding |
| Type0A- | Common | SI-RNTI on a primary cell | SIB |
| PDCCH | | | Decoding |
| Type1- | Common | RA-RNTI or TC-RNTI on a | Msg2, Msg4 |
| PDCCH | | primary cell | decoding in |
| | | | RACH |
| Type2- | Common | P-RNTI on a primary cell | Paging |
| PDCCH | | | Decoding |
| Type3- | Common | INT-RNTI, SFI-RNTI, TPC- | |
| PDCCH | | PUSCH-RNTI, TPC-PUCCH- | |
| | | RNTI, TPC-SRS-RNTI, C-RNTI, | |
| | | MCS-C-RNTI, or CS-RNTI(s) | |
| UE | UE | C-RNTI, or MCS-C-RNTI, or CS- | User specific |
| Specific | Specific | RNTI(s) | PDSCH |
| | | | decoding |

Table 4 shows DCI formats transmitted on the PDCCH.

TABLE 4

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM |
| | symbol(s) where UE may assume no transmission is |
| | intended for the UE |
| 2_2 | Transmission of TPC commands for PUCCH and PUSCH |
| 2_3 | Transmission of a group of TPC commands for SRS |
| | transmissions by one or more UEs |

DCI format 0_0 may be used to schedule a TB-based (or TB-level) PUSCH, and DCI format 0_1 may be used to schedule a TB-based (or TB-level) PUSCH or a code block group (CBG)-based (or CBG-level) PUSCH. DCI format 1_0 may be used to schedule a TB-based (or TB-level) PDSCH, and DCI format 1_1 may be used to schedule a TB-based (or TB-level) PDSCH or a CBG-based (or CBG-level) PDSCH (DL grant DCI). DCI format 0_0/0_1 may be referred to as UL grant DCI or UL scheduling information, and DCI format 1_0/1_1 may be referred to as DL grant DCI or DL scheduling information. DCI format 2_0 is used to deliver dynamic slot format information (e.g., a dynamic slot format indicator (SFI)) to a UE, and DCI format 2_1 is used to deliver DL pre-emption information to a UE. DCI format 2_0 and/or DCI format 21 may be delivered to a corresponding group of UEs on a group common PDCCH which is a PDCCH directed to a group of UEs.

DCI format 0_0 and DCI format 1_0 may be referred to as fallback DCI formats, whereas DCI format 0_1 and DCI format 1_1 may be referred to as non-fallback DCI formats. In the fallback DCI formats, a DCI size/field configuration is maintained to be the same irrespective of a UE configuration. In contrast, the DCI size/field configuration varies depending on a UE configuration in the non-fallback DCI formats.

A CCE-to-REG mapping type is configured as one of an interleaved CCE-to-REG type and a non-interleaved CCE-to-REG type.
Non-interleaved CCE-to-REG mapping (or localized CCE-to-REG mapping) (FIG. 5): 6 REGs for a given CCE are grouped into one REG bundle, and all of the REGs for the given CCE are contiguous. One REG bundle corresponds to one CCE.
Interleaved CCE-to-REG mapping (or distributed CCE-to-REG mapping): 2, 3 or 6 REGs for a given CCE are grouped into one REG bundle, and the REG bundle is interleaved within a CORESET. In a CORESET including one or two OFDM symbols, an REG bundle includes 2 or 6 REGs, and in a CORESET including three OFDM symbols, an REG bundle includes 3 or 6 REGs. An REG bundle size is set on a CORESET basis.

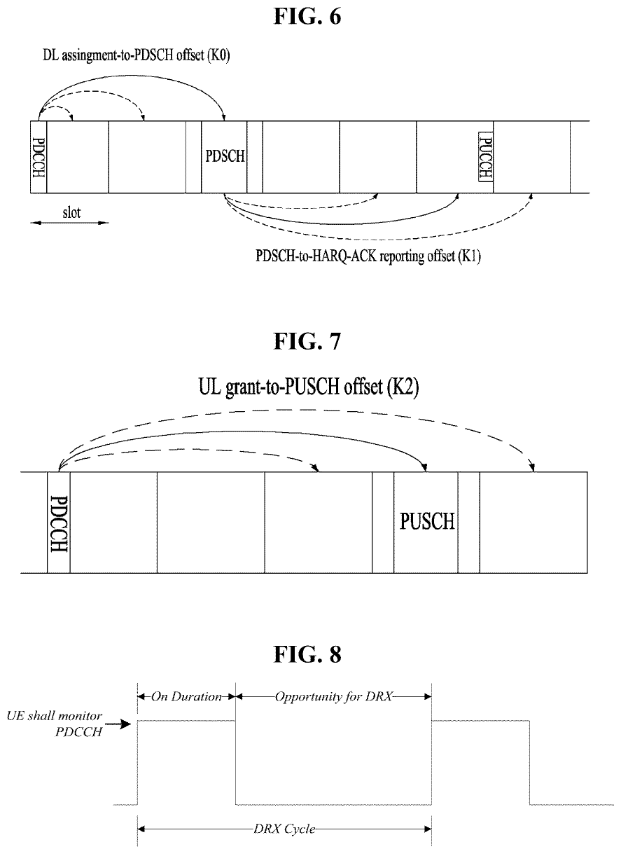

FIG. 6 illustrates an exemplary PDSCH reception and ACK/NACK transmission process. Referring to FIG. 6, the UE may detect a PDCCH in slot #n. The PDCCH includes DL scheduling information (e.g., DCI format 1_0 or DCI format 1_1), and indicates a DL assignment-to-PDSCH offset, KG and a PDSCH-HARQ-ACK reporting offset, K1. For example, DCI format 1_0 or DCI format 1_1 may include the following information.
Frequency domain resource assignment: Indicates an RB set allocated to a PDSCH.
Time domain resource assignment: Indicates K0 (e.g., slot offset), the starting position (e.g., OFDM symbol index) of the PDSCH in slot #n+K0, and the duration (e.g., the number of OFDM symbols) of the PDSCH. As described above, a row index of pdsch-TimeDomainAllocationList provided UE-commonly or UE-specifically may be indicated by a TDRA field.
PDSCH-to-HARQ_feedback timing indicator: Indicates K1.
HARQ process number (4 bits): Indicates the HARQ process ID of data (e.g., a PDSCH or TB).
PUCCH resource indicator (PRI): Indicates a PUCCH resource to be used for UCI transmission among a plurality of PUCCH resources in a PUCCH resource set.

After receiving a PDSCH in slot #(n+K0) according to the scheduling information of slot #n, the UE may transmit UCI on a PUCCH in slot #(n+K1). The UCI may include an HARQ-ACK response to the PDSCH. FIG. 5 is based on the assumption that the SCS of the PDSCH is equal to the SCS of the PUCCH, and slot #n1=slot #(n+K0), for convenience, which should not be construed as limiting the disclosure. When the SCSs are different, K1 may be indicated/interpreted based on the SCS of the PUCCH.

In the case where the PDSCH is configured to carry one TB at maximum, the HARQ-ACK response may be configured in one bit. In the case where the PDSCH is configured to carry up to two TBs, the HARQ-ACK response may be configured in 2 bits if spatial bundling is not configured and in 1 bit if spatial bundling is configured. When slot #(n+K1) is designated as an HARQ-ACK transmission timing for a plurality of PDSCHs, UCI transmitted in slot #(n+K1) includes HARQ-ACK responses to the plurality of PDSCHs.

Whether the UE should perform spatial bundling for an HARQ-ACK response may be configured for each cell group (e.g., by RRC/higher layer signaling). For example, spatial bundling may be configured for each individual HARQ-ACK response transmitted on the PUCCH and/or HARQ-ACK response transmitted on the PUSCH.

When up to two (or two or more) TBs (or codewords) may be received at one time (or schedulable by one DCI) in a corresponding serving cell (e.g., when a higher layer parameter maxNrofCodeWordsScheduledByDCI indicates 2 TBs), spatial bundling may be supported. More than four layers may be used for a 2-TB transmission, and up to four layers may be used for a 1-TB transmission. As a result, when spatial bundling is configured for a corresponding cell group, spatial bundling may be performed for a serving cell in which more than four layers may be scheduled among serving cells of the cell group. A UE which wants to transmit an HARQ-ACK response through spatial bundling may generate an HARQ-ACK response by performing a (bit-wise) logical AND operation on A/N bits for a plurality of TBs.

For example, on the assumption that the UE receives DCI scheduling two TBs and receives two TBs on a PDSCH based on the DCI, a UE that performs spatial bundling may generate a single A/N bit by a logical AND operation between a first A/N bit for a first TB and a second A/N bit for a second TB. As a result, when both the first TB and the second TB are ACKs, the UE reports an ACK bit value to a BS, and when at least one of the TBs is a NACK, the UE reports a NACK bit value to the BS.

For example, when only one TB is actually scheduled in a serving cell configured for reception of two TBs, the UE may generate a single A/N bit by performing a logical AND operation on an A/N bit for the one TB and a bit value of 1. As a result, the UE reports the A/N bit for the one TB to the BS.

There are plurality of parallel DL HARQ processes for DL transmissions at the BS/UE. The plurality of parallel HARQ processes enable continuous DL transmissions, while the BS is waiting for an HARQ feedback indicating successful or failed reception of a previous DL transmission. Each HARQ process is associated with an HARQ buffer in the medium access control (MAC) layer. Each DL HARQ process manages state variables such as the number of MAC physical data unit (PDU) transmissions, an HARQ feedback for a MAC PDU in a buffer, and a current redundancy version. Each HARQ process is identified by an HARQ process ID.

FIG. 7 illustrates an exemplary PUSCH transmission procedure. Referring to FIG. 7, the UE may detect a PDCCH in slot #n. The PDCCH includes DL scheduling information (e.g., DCI format 1_0 or 1_1). DCI format 1_0 or 1_1 may include the following information.
Frequency domain resource assignment: Indicates an RB set assigned to the PUSCH.
Time domain resource assignment: Indicates a slot offset K2 and the starting position (e.g., OFDM symbol index) and duration (e.g., the number of OFDM symbols) of the PUSCH in a slot. The starting symbol and length of the PUSCH may be indicated by a start and length indicator value (SLIV), or separately.

The UE may then transmit a PUSCH in slot #(n+K2) according to the scheduling information in slot #n. The PUSCH includes a UL-SCH TB.

### DRX (Discontinuous Reception)

### (1) RRC CONNECTED DRX

FIG. 8 is a diagram illustrating a DRX operation of a UE according to an embodiment of the disclosure.

The UE may perform a DRX operation in the afore-described/proposed procedures and/or methods. A UE configured with DRX may reduce power consumption by receiving a DL signal discontinuously. DRX may be performed in an RRC_IDLE state, an RRC_INACTIVE state, and an RRC_CONNECTED state. The UE performs DRX to receive a paging signal discontinuously in the RRC_IDLE state and the RRC_INACTIVE state. DRX in the RRC_CONNECTED state (RRC_CONNECTED DRX) will be described below.

Referring to FIG. 8, a DRX cycle includes an On Duration and an Opportunity for DRX. The DRX cycle defines a time interval between periodic repetitions of the On Duration. The On Duration is a time period during which the UE monitors a PDCCH. When the UE is configured with DRX, the UE performs PDCCH monitoring during the On Duration. When the UE successfully detects a PDCCH during the PDCCH monitoring, the UE starts an inactivity timer and is kept awake. On the contrary, when the UE fails in detecting any PDCCH during the PDCCH monitoring, the UE transitions to a sleep state after the On Duration. Accordingly, when DRX is configured, PDCCH monitoring/reception may be performed discontinuously in the time domain in the afore-described/proposed procedures and/or methods. For example, when DRX is configured, PDCCH reception occasions (e.g., slots with PDCCH SSs) may be configured discontinuously according to a DRX configuration in an embodiment of the disclosure. On the contrary, when DRX is not configured, PDCCH monitoring/reception may be performed continuously in the time domain. For example, when DRX is not configured, PDCCH reception occasions (e.g., slots with PDCCH SSs) may be configured continuously in an embodiment of the disclosure. Irrespective of whether DRX is configured, PDCCH monitoring may be restricted during a time period configured as a measurement gap.

Table 5 describes a DRX operation of a UE (in the RRC_CONNECTED state). Referring to Table 5, DRX configuration information is received by higher-layer signaling (e.g., RRC signaling), and DRX ON/OFF is controlled by a DRX command from the MAC layer. Once DRX is configured, the UE may perform PDCCH monitoring discontinuously in performing the afore-described/proposed procedures and/or methods.

TABLE 5

| | Type of signals | UE procedure |
|---|---|---|
| 1st step | RRC signalling | Receive DRX configuration information |
| | (MAC- | |
| | CellGroupConfig) | |
| 2nd Step | MAC CE | Receive DRX command |
| | ((Long) DRX | |
| | command MAC CE) | |
| 3rd Step | — | Monitor a PDCCH during an on- |
| | | duration of a DRX cycle |

MAC-CellGroupConfig includes configuration information required to configure MAC parameters for a cell group. MAC-CellGroupConfig may also include DRX configuration information. For example, MAC-CellGroupConfig may include the following information in defining DRX.
Value of drx-OnDurationTimer: defines the duration of the starting period of the DRX cycle.
Value of drx-InactivityTimer: defines the duration of a time period during which the UE is awake after a PDCCH occasion in which a PDCCH indicating initial UL or DL data has been detected
Value of drx-HARQ-RTT-TimerDL: defines the duration of a maximum time period until a DL retransmission is received after reception of a DL initial transmission.
Value of drx-HARQ-RTT-TimerDL: defines the duration of a maximum time period until a grant for a UL retransmission is received after reception of a grant for a UL initial transmission.
drx-LongCycleStartOffset: defines the duration and starting time of a DRX cycle.
drx-ShortCycle (optional): defines the duration of a short DRX cycle.

When any of drx-OnDurationTimer, drx-InactivityTimer, drx-HARQ-RTT-TimerDL, and drx-HARQ-RTT-TimerDL is running, the UE performs PDCCH monitoring in each PDCCH occasion, staying in the awake state.

### RRC_IDLE_DRX

In the RRC_IDLE and RRC_INACTIVE states, DRX is used to receive a paging signal discontinuously. For simplicity, DRX performed in the RRC_IDLE (or RRC_INACTIVE) state will be referred to as RRC_IDLE DRX.

Therefore, if DRX is configured, PDCCH monitoring/reception may be performed discontinuously in the time domain in performing the above-described/proposed procedures and/or methods are performed.

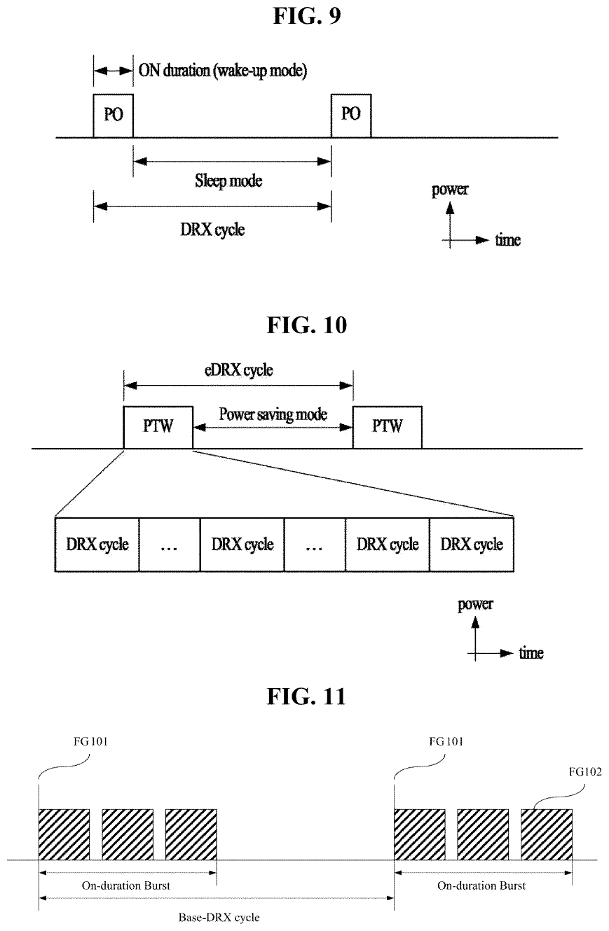

FIG. 9 illustrates an exemplary DRX cycle for paging.

Referring to FIG. 9, DRX may be configured for discontinuous reception of a paging signal. The UE may receive DRX configuration information from the BS by higher-layer (e.g., RRC) signaling. The DRX configuration information may include configuration information related to a DRX cycle, a DRX offset, a DRX timer, and the like. The UE repeats an On duration and a Sleep duration according to the DRX cycle. The UE may operate in a wakeup mode during the On duration and in a sleep mode during the Sleep duration.

In the wakeup mode, the UE may monitor a PO to receive a paging message. A PO means a time resource/interval (e.g., subframe or slot) in which the UE expects to receive a paging message. PO monitoring includes monitoring a PDCCH (MPDCCH or NPDCCH) scrambled with a P-RNTI (hereinafter, referred to as a paging PDCCH) on a PO. The paging message may be included in the paging PDCCH or in a PDSCH scheduled by the paging PDCCH. One or more POs may be included in a paging frame (PF), and the PF may be periodically configured based on a UE ID. A PF may correspond to one radio frame, and the UE ID may be determined based on the International Mobile Subscriber Identity (IMSI) of the UE. When DRX is configured, the UE monitors only one PO per DRX cycle. When the UE receives a paging message indicating a change of its ID and/or system information on a PO, the UE may perform a RACH procedure to initialize (or reconfigure) a connection with the BS, or receive (or obtain) new system information from the BS. Therefore, PO monitoring may be performed discontinuously in the time domain to perform a RACH procedure for connection to the BS or to receive (or obtain) new system information from the BS in the above-described procedures and/or methods.

FIG. 10 illustrates an extended DRX (eDRX) cycle.

According to the DRX cycle configuration, the maximum cycle duration may be limited to 2.56 seconds. However, in the case of a UE that intermittently performs data transmission/reception, such as an MTC UE or an NB-IoT UE, unnecessary power consumption may occur during the DRX cycle. In order to further reduce the power consumption of the UE, a method of significantly extending the DRX cycle based on a power saving mode (PSM) and a paging time window or paging transmission window (PTW) has been introduced. The extended DRX cycle is simply referred to as an eDRX cycle. Specifically, paging hyper-frames (PHs) are periodically configured based on the UE ID, and a PTW is defined in the PHs. The UE may perform a DRX cycle in the PTW duration to switch to the wakeup mode on the PO thereof to monitor the paging signal. One or more DRX cycles (e.g., wake-up mode and sleep mode) of FIG. 9 may be included in the PTW duration. The number of DRX cycles in the PTW duration may be set by the BS through a higher layer (e.g., RRC) signal.

### Mini-DRX Operation for UE Power Saving

In NR, a DRX operation may be used to reduce unnecessary power consumption of a UE. A DRX structure for UEs in the RRC_IDLE state and a DRX structure for UEs in the RRC_CONNECTED state are defined, respectively, and both DRX structures are designed to periodically generate a period during which the UE may expect to receive a DL signal, so that unnecessary power consumption is reduced in the other periods. Specifically, in C-DRX (i.e. DRX applied to UEs in the RRC_CONNECTED state), the starting position of an On-duration occurs periodically based on the Rel-16 standard of NR, and the size (i.e. DRX cycle) of a configurable period may be determined by a higher layer parameter that the BS provides to the UE. Table 6 is an excerpt from the TS 38.331 standard, and illustrates some of the parameters that determine a C-DRX cycle. As illustrated in Table 6 below, the BS may indicate one or two types of DRX (i.e., long, short) to the UE, and both types of DRX cycles have fixed integer sizes.

TABLE 6
drx-LongCycleStartOffset CHOICE {

| ms10 | INTEGER(0..9), | |
|---|---|---|
| ms20 | INTEGER(0..19), | |
| ms32 | INTEGER(0..31), | |
| ms40 | INTEGER(0..39), | |
| ms60 | INTEGER(0..59), | |
| ms64 | INTEGER(0..63), | |
| ms70 | INTEGER(0..69), | |
| ms80 | INTEGER(0..79), | |
| ms128 | INTEGER(0..127), | |
| ms160 | INTEGER(0..159), | |
| ms256 | INTEGER(0..255), | |
| ms320 | INTEGER(0..319), | |
| ms512 | INTEGER(0..511), | |
| ms640 | INTEGER(0..639), | |
| ms1024 | | INTEGER(0..1023), |
| ms1280 | | INTEGER(0..1279), |
| ms2048 | | INTEGER(0..2047), |
| ms2560 | | INTEGER(0..2559), |
| ms5120 | | INTEGER(0..5119), |

| | |
|---|---|
| ms10240 | INTEGER(0..10239) |

```
  },
shortDRX SEQUENCE {
  drx-ShortCycleENUMERATED {
  ms2, ms3, ms4, ms5, ms6, ms7, ms8, ms10, ms14, ms16, ms20, ms30,
  ms32, ms35, ms40, ms64, ms80, ms128, ms160, ms256, ms320,
  ms512, ms640, spare9, spare8, spare7, spare6, spare5, spare4, spare3,
  spare2, spare1 },
  drx-ShortCycleTimer INTEGER (1..16)
  } OPTIONAL, -- Need R
```

In 3GPP, various scenarios and candidate technologies are under discussion to support XR services. XR is characterized in that low latency should be satisfied, while high data rates are guaranteed, and at the same time, high power consumption of UEs is expected. Accordingly, various power saving techniques are considered to increase battery efficiency. To prevent unnecessary power consumption of UEs, a situation where a DRX operation is also applied to XR UEs may be considered.

A DRX operation may be useful in a system in which periodic traffic is expected. On the contrary, when a traffic generation period is not regular and there is a high level of latency requirement for traffic, the DRX operation may increase latency, and in a worse case, result in traffic transmission and reception failure. For example, in the case of XR traffic, although it is expected that traffic will be generated with a certain periodicity, jitter caused by information processing and event occurrence needs to be considered. In this case, the occurrence of jitter may mean that traffic is generated or transmitted and received not at a fixed time but earlier or later than an expected time. For example, when the expected time of traffic generation or transmission and reception is t, it may be necessary to design a system which considers the possibility of traffic generation or transmission and reception within a range of [t−t′, t+t′] due to the occurrence of jitter.

In a situation where a DRX structure is used, one way to ensure transmission and reception of traffic generated in consideration of the influence of jitter in each DRX cycle is to increase the length of a period (e.g. On-duration timer) in which the UE maintains PDCCH monitoring even when there is no PDCCH transmission or reception. However, this method may be disadvantageous in that the PDCCH monitoring period increases regardless of whether traffic is generated actually, thereby significantly increasing the average power consumption of the UE. On the other hand, a method of considering the influence of jitter may be used, in which instead of setting the length of the On-duration timer to be small, the DRX cycle is reduced so that the UE wakes up more frequently than an actual traffic generation period. However, this method increases unnecessary PDCCH monitoring of the UE by generating a period with no actual traffic in a DRX cycle.

To address the above problems, the disclosure proposes a method of obtaining a power saving effect for a UE in a situation where a periodic UE operation such as DRX is considered. This may be advantageous for obtaining a power saving gain in traffic transmission/reception which is periodic but vulnerable to jitter.

While the disclosure is described mainly in the context of applying a C-DRX operation to a UE in the RRC_CONNECTED state in the 3GPP NR system, the disclosure is not limited thereto and may also be applied to other methods (e.g. DRX applied to a UE in the RRC_IDLE state) of defining a certain period with a periodicity, in which the UE does not need to expect reception of a DL signal. Therefore, the term DRX is used as a general concept covering C-DRX, for convenience of description.

A DRX operation disclosed herein is described mainly in the context of a structure in which a period in which a UE may start performing PDCCH monitoring is repeated with a periodicity. However, the disclosure is not limited thereto, and may also be applied to a DRX operation with an aperiodic structure. For example, the disclosure may also be applied to a DRX operation with a non-integer periodicity or a DRX operation with the size of a DRX cycle expressed in the form of a pattern. The disclosure is described in the context of, but not limited, to an NR system. Further, although the disclosure is described based on the characteristics and structure of an XR service, the disclosure is not limited to the XR service. Each of the methods proposed in the disclosure may be performed independently without being combined with other methods, or one or more methods may be combined and performed in conjunction with each other. Some terms, symbols, and orders used for the description of the disclosure may be replaced with other terms, symbols, and orders.

A structure is considered, in which a BS provides DRX parameter information through configuration information (e.g. RRC signaling) and a UE receives it and performs a DRX operation. There is at least one DRX cycle configured by the BS, and operations that may be repeated based on the DRX cycle are proposed. In the disclosure, the above DRX cycle is defined using the term Base-DRX, for convenience of description.

A situation is considered in which when a UE performs a DRX operation, a time period is configured in which the UE may expect transmission and reception of a specific signal/channel. The UE may expect to transmit and receive the specific signal/channel only in the time period, whereas the UE may not expect to transmit and receive the signal/channel in the other periods, except when a separate condition is satisfied. This may be intended to obtain a power saving effect for the UE. Specifically, the transmission and reception of the specific signal/channel may be determined based on the UE's monitoring of PDCCHs with specific RNTIs, and the time period may be determined as a period in which PDCCH monitoring is performed. For example, the time period may be a period (i.e. On-duration) in which an On-duration timer used in a system such as LTE/NR operates. While the proposals are described below based on a method of controlling an On-duration, they are also applicable to cases where other general signal/channel and time period definitions are used, unless otherwise noted.

In the disclosure, the proposals may be applied only when a UE receives related configuration information from a BS (or core network). The configuration information may be indicated through a higher layer signal (e.g. an SIB or RRC signaling) or together with a method of activating/deactivating the configured information by separate signaling (e.g. DCI or MAC). Further, the UE may report information (e.g. capability information) about whether the proposals are supported, and the BS (or core network) may receive it.

### [Proposal 1] Configuration of On-Duration Burst Generated in Each Base-DRX Cycle

As one way to consider the increase of a timer period in which traffic may be generated due to the influence of jitter in a system where traffic is transmitted and received in each Base-DRX cycle, a method of configuring an On-duration burst is proposed. The On-duration burst may be a time period generated in each Base-DRX cycle, and one or more On-durations may be generated in the period. Hereinafter, a structure in which one or more On-durations are repeated in an On-duration burst is defined as mini-DRX, and an operation accompanying repetition of one or more On-durations in an On-duration burst is defined as a mini-DRX operation. Further, each On-duration burst may be defined as an On-duration set including one or more On-durations. Accordingly, an On-duration burst may also be referred to as an On-duration set.

FIG. 11 illustrates an example of Proposal 1. FIG. 11 is only an example, to which the disclosure is not limited. Referring to FIG. 11, the starting time FG101 of an On-duration burst is determined in each Base-DRX cycle, and an On-duration FG102 is repeatedly generated in the On-duration burst.

In FIG. 11, a situation is considered in which a UE receives a higher layer signal (e.g. an SIB or RRC signaling) including DRX information from a BS, and performs DRX and mini-DRX operations based on the received higher layer signal. The DRX information may include Base-DRX-related parameters (e.g. a Base-DRX reference position, an On-duration burst length, and/or a cycle), and further include mini-DRX-related parameters (e.g. a mini-DRX reference position, an On-duration length, and/or a mini-DRX cycle).

The UE may expect that an On-duration burst will start in each Base-DRX cycle, and the starting position of the On-duration burst may be calculated from the Base-DRX-related parameters received from the BS.

The UE may perform the mini-DRX operation within the On-duration burst. The UE which performs the mini-DRX operation may expect that On-durations may be generated sequentially at determined positions in the On-duration burst, and perform required PDCCH monitoring in the On-durations.

The mini-DRX operation may be performed until the On-duration burst ends. When the On-duration burst ends, the UE may terminate the mini-DRX operation, and then start the next On-duration burst at a position determined based on the Base-DRX cycle.

For example, a case may be considered in which a DRX structure is used for the purpose of transmitting and receiving traffic of a service with specific requirements on a 3GPP-based wireless communication channel such as LTE and NR channels. The UE may assume that the mini-DRX operation is performed at the starting position of an On-duration burst determined according to Base-DRX configuration information, and an On-duration timer may be set to start at the starting positions of On-durations determined according to mini-DRX configuration information. In a period during which the On-duration timer is maintained, the UE may perform an operation such as PDCCH monitoring, and when the UE succeeds in detecting a PDCCH, it may perform subsequent operation(s) according to a predetermined procedure. When the On-duration burst ends, the UE may assume that the mini-DRX operation ends, and a new On-duration will not start until the next Base-DRX cycle starts.

When the DRX structure is used for the purpose of transmitting and receiving traffic of a service with specific requirements, an On-duration may be in the form of a window or a mask. In this case, an On-duration burst may have the same meaning as an On-duration defined in the legacy standards. In the mini-DRX operation, the UE may perform an operation such as PDCCH monitoring at determined positions, expecting that a window (or mask) will be repeated with a determined size at the determined positions in the On-duration burst, and when succeeding in detecting a PDCCH, the UE may perform subsequent operation(s) according to a predetermined procedure.

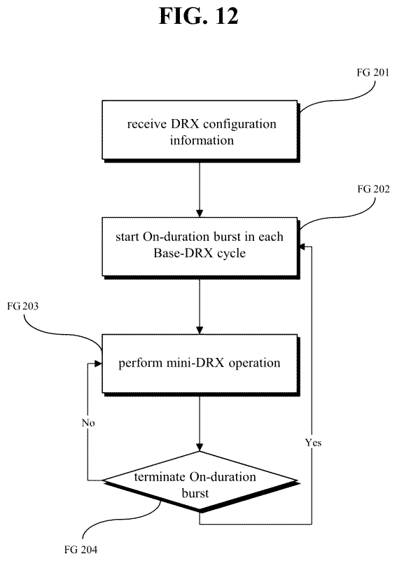

FIG. 12 illustrates an exemplary UE operation.

The UE may receive DRX configuration information (FG201). The DRX configuration information may include parameters for configuring Base-DRX and parameters for configuring mini-DRX. For example, the configuration information may be transmitted through a higher layer signal (e.g. an SIB or RRC signaling).

Then, the UE may expect that an On-duration burst will start at the starting time of the On-duration burst, determined in each Base-DRX cycle, based on the received DRX configuration information, and perform a related operation (FG202).

In this case, the UE may expect that one or more On-durations may be generated in the On-duration burst, and perform the mini-DRX operation at the positions of the On-durations (FG203). For example, the mini-DRX operation may include PDCCH monitoring at the positions of the On-durations generated in the On-duration burst.

When the On-duration burst is maintained (FG204), the UE may maintain the mini-DRX operation (FG203). When the On-duration burst ends (FG204), the UE may terminate the mini-DRX operation and perform an operation based on the next Base-DRX (FG202).

In FIG. 12, a situation is considered in which a BS transmits a higher layer signal (e.g. an SIB or RRC signaling) including DRX information, and a signal/channel is transmitted and received in consideration of DRX and mini-DRX operations based on the transmitted higher layer signal. The DRX information may include Base-DRX-related parameters (e.g. a Base-DRX reference position, an On-duration burst length, and/or a cycle) and further include mini-DRX-related parameters (e.g. a mini-DRX reference position, an On-duration length, and/or a mini-DRX cycle).

The BS may expect that the UE will perform the mini-DRX operation in an On-duration burst configured in each Base-DRX cycle based on the transmitted DRX configuration information, and transmit a PDCCH in an On-duration belonging to the On-duration burst.

For example, a case may be considered in which the DRX structure is used for the purpose of transmitting and receiving traffic of a service with specific requirements on a 3GPP-based wireless communication channel such as LTE and NR channels. The BS may assume that the UE will perform the mini-DRX operation at the starting position of an On-duration burst determined according to Base-DRX configuration information and start an On-duration timer at the starting position(s) of On-duration(s) determined according to mini-DRX configuration information.

When the DRX structure is used for the purpose of transmitting and receiving traffic of a service with specific requirements, an On-duration may be in the form of a window or a mask. In this case, an On-duration burst may have the same meaning as an On-duration defined in the legacy standards. Herein, the BS may regulate that the UE assumes that it may perform an operation such as PDCCH monitoring in windows (or masks) with a determined size at determined positions in the On-duration burst through the mini-DRX operation.

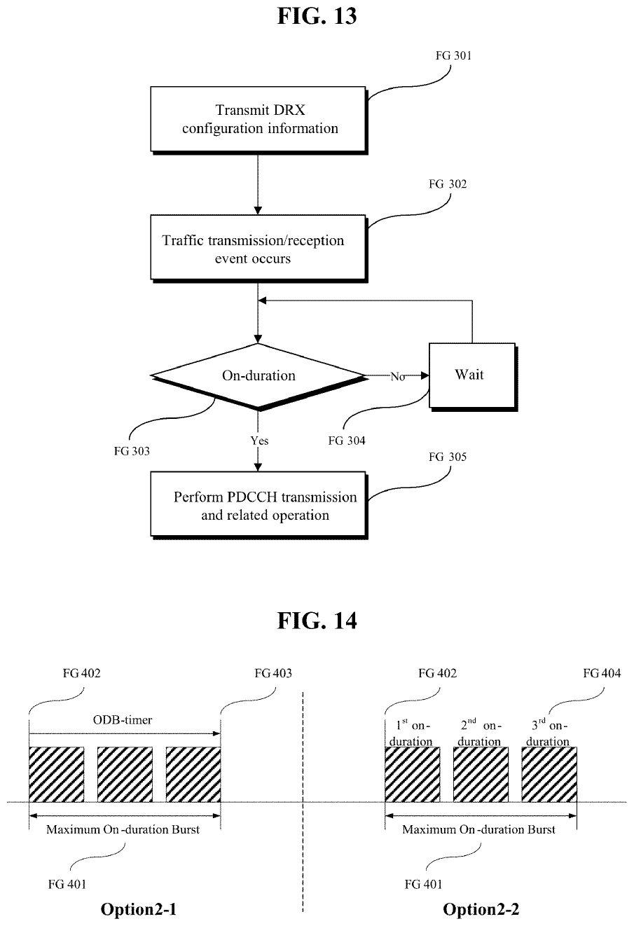

FIG. 13 illustrates an exemplary BS operation.

Referring to FIG. 13, a BS may generate and transmit DRX configuration information (FG301). The DRX configuration information may include parameters for configuring Base-DRX and parameters for configuring mini-DRX. For example, the configuration information may be transmitted through a higher layer signal (e.g. an SIB or RRC signaling).

The BS may then need to transmit DL traffic or receive UL traffic (FG302).

In a period other than an On-duration determined based on the configuration information (FG303), the BS may wait without transmitting a PDCCH for scheduling transmission/reception of the DL or UL traffic until an On-duration starts (FG304).

In an On-duration determined based on the configuration information (FG303), the BS may transmit the PDCCH for scheduling transmission/reception of the DL or UL traffic and perform a related operation (FG305).

In a more general case, a decision as to whether a period is an On-duration may be included in a decision as to whether the period is an active time (i.e. a period in which the UE may expect transmission/reception of a PDCCH for a specific purpose, when the UE performs a DRX operation) in a system such as LTE/NR. For example, it may be determined whether the period is an active time by checking whether drx-onDurationTimer, drx-InactivityTimer, drx-RetransmissionTimerDL or drx-RetransmissionTimerUL is running.

The example of Proposal 1 may be advantageous in obtaining the power saving effect for the UE in a situation where although traffic occurs periodically like XR, a traffic transmission/reception timing may be variable due to jitter caused by a processing time of a transmitter/receiver. This may have the effect of increasing a period in which the UE may monitor a PDCCH for traffic scheduling by configuring an On-duration burst including a plurality of contiguous On-durations.

Compared to a method of increasing the length of one On-duration while maintaining the existing DRX structure, this may be effective in that it provides an opportunity for the BS to adjust latency and the power saving effect as needed, because each On-duration in the On-duration burst may be used as a unit that is individually controllable.

### [Proposal 2] Setting of Maximum Length of On-Duration Burst

When an On-duration burst is configured, a method of setting a maximum length of the On-duration burst is proposed. The maximum length of the On-duration burst means a length from the starting time to the ending time of the On-duration burst until which the On-duration burst may be maintained. In consideration of the presence of another condition for early termination of the On-duration burst, this may be intended to prevent excessive power consumption of the UE by setting a condition of terminating the On-duration burst even when the condition for early termination is not satisfied. When the On-duration burst reaches the maximum length without early termination, a mini-DRX operation performed in the On-duration burst may be terminated, or when there is a mini-DRX operation already in progress, it may be performed and then terminated.

Specifically, the maximum length of the On-duration burst may be determined according to at least one of the following options.
Option 2-1: A period during which a timer (hereinafter, referred to as ODB-timer) starting from the starting time of an On-duration burst is maintained.
Option 2-2: The number (hereinafter, referred to as Max-OD) of On-durations generated from the starting time of an On-duration burst

When Option 2-1 is used, the On-duration burst may be determined to be valid only until a time when the ODB-timer ends. The ODB-timer may be set to be calculated cumulatively from the starting time of the On-duration burst, and a unit for the calculation may be, for example, an absolute time unit (e.g., ms), a transmission/reception unit (e.g. OFDM symbol, slot, frame, or the like) in the time domain used in a wireless communication system, or a transmission/reception unit (e.g. valid symbol, slot, or the like) available for actual DL and/or UL transmission/reception of the BS and UE among time-domain transmission/reception units used in a wireless communication system.

When Option 2-2 is used, the On-duration burst may be maintained until the number of On-durations generated in the On-duration burst is equal to the Max-OD. The number of On-durations may be counted cumulatively from the starting time of the On-duration burst, and for example, the number of times the On-duration timer starts (or ends) or the number of occurrences of timings at which the On-duration timer may start (or end) according to mini-DRX configuration information (i.e. including timings at which the On-duration timer does not actually start) may be calculated.

FIG. 14 illustrates an example in which Option 2-1 and Option 2-2 are applied. FIG. 14 is only an example, to which the disclosure is not limited.

In an example of Option 2-1, the starting time FG401 of an On-duration burst is determined in each Base-DRX cycle, and a maximum length FG404 of the On-duration burst is determined based on the ending time FG402 of an ODB-timer that operates from the starting time FG401.

Further, in an example of Option 2-2, the starting time FG401 of an On-duration burst is determined in each Base-DRX cycle, and a maximum length FG404 of the On-duration burst is determined based on the ending time of a Max-OD^{th} On-duration FG404.

For example, a method is considered in which a UE receives information related to a maximum length of an On-duration burst from a BS, and calculates a period in which the On-duration burst may be maintained based on the information. The information may be a higher layer signal (e.g. an SIB or RRC signaling) including DRX information. The information about the maximum length of the On-duration burst may be information about an ODB-timer as in Option 2-1 or a Max-OD value as in Option 2-2.

The UE may expect that an On-duration burst will start in each Base-DRX cycle and calculate a maximum period in which the On-duration burst may be maintained by applying the maximum length of the On-duration burst from the starting position of the On-duration burst.

The UE may assume that the On-duration burst is maintained until the ending position of the On-duration burst, calculated by applying the maximum length of the On-duration burst, until before an early termination condition occurs for the started On-duration burst. In the period in which the On-duration burst is maintained, the UE may perform the mini-DRX operation.

After the ending time of the On-duration burst calculated by applying the maximum length of the On-duration burst, the UE may terminate the mini-DRX operation, assuming that the maintained On-duration burst has ended. Subsequently, the UE may start the next On-duration burst at a position determined based on a Base-DRX cycle.

A case may be considered in which the DRX structure is used for the purpose of transmitting and receiving traffic of a service with specific requirements. In this case, the UE may assume that the mini-DRX operation is performed at the starting position of an On-duration burst determined according to Base-DRX configuration information. Further, the UE may obtain information about a maximum length for which the On-duration burst started according to the configuration information received from the BS may be maintained. When the configuration information includes information such as an ODB-timer, the UE may run the ODB-timer runs from the starting position of the On-duration burst, and assume that the maintained On-duration burst ends based on the ending time of the ODB-timer. Alternatively, when the configuration information includes information such as a Max-OD, the UE may cumulatively calculate the number of On-durations generated from the starting position of the On-duration burst and assume that the maintained On-duration burst ends, when the calculated value is equal to the Max-OD value.

When the DRX structure is used for the purpose of transmitting and receiving traffic of a service with specific requirements, an On-duration may be in the form of a window or a mask. In this case, when the configuration information includes information such as an ODB-timer, the UE may run the ODB-timer from the starting position of the On-duration burst, and assume that the maintained On-duration burst ends based on the ending time of the ODB-timer. Alternatively, when the configuration information includes information such as a Max-OD, the UE may cumulatively calculate the number of windows (or masks) occurring from the starting position of the On-duration burst, and assume that the maintained On-duration burst ends, when the calculated value is equal to the Max-OD value.

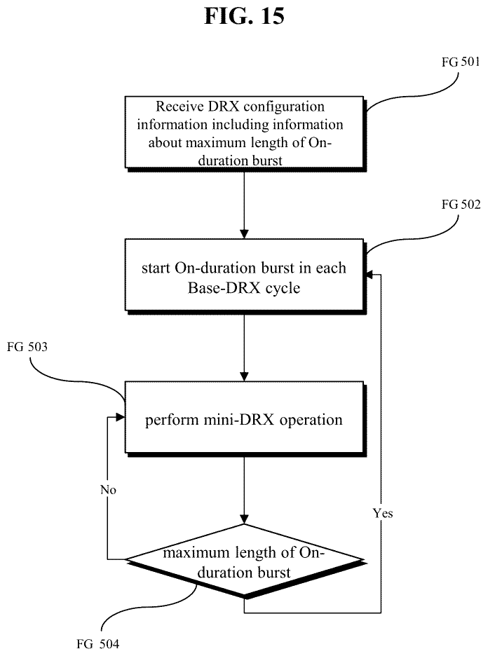

FIG. 15 illustrates an exemplary UE operation.

Referring to FIG. 15, the UE may receive DRX configuration information including information about a maximum length of an On-duration burst (FG501). The information about the maximum length of the On-duration burst may be timer information about the On-duration burst or information about a maximum number of On-durations that may be generated in the On-duration burst. For example, the configuration information may be received through a higher layer signal (e.g. an SIB or RRC signaling).

Then, the UE may expect that the On-duration burst will start at the starting time of the On-duration burst, determined in each Base-DRX cycle, based on the received DRX configuration information, and perform a related operation (FG502).

The UE may expect that one or more On-durations may be generated in the On-duration burst and perform the mini-DRX operation at positions of the On-durations (FG503). For example, the mini-DRX operation may include PDCCH monitoring at the positions of the On-durations generated in the On-duration burst.

The UE may use the information about the maximum length of the On-duration burst to determine whether the started On-duration burst is maintained (FG504). When the On-duration burst is maintained, the UE may determine to maintain the mini-DRX operation (FG503), and when the On-duration burst ends (FG504), the UE may determine to terminate the mini-DRX operation and perform an operation based on the next Base-DRX (FG502). When a timer value is set, a criterion for determining whether to maintain the On-duration burst may be set as a time when the timer ends, or when a maximum number of On-durations is set, the criterion may be set as the number of On-durations generated in the On-duration burst.

For example, a method is considered in which a BS provides information related to the maximum length of an On-duration burst to a UE, and a period in which the On-duration burst may be maintained is configured based on the information. The information may be provided through a higher layer signal (e.g. an SIB or RRC signaling) including DRX information. The information about the maximum length of the On-duration burst may be information about an ODB-timer as in Option 2-1 or a Max-OD value as in Option 2-2.

The BS may expect that the UE will perform the mini-DRX operation in the On-duration burst in each Base-DRX cycle based on the transmitted DRX configuration information, and may transmit a PDCCH in an On-duration belonging to the On-duration burst, when needed. The BS may calculate a maximum period in which the On-duration burst may be maintained by applying the maximum length of the On-duration burst from the starting position of the On-duration burst.

The BS may assume that after the ending time of the On-duration burst calculated by applying the maximum length of the On-duration burst, the UE will terminate the mini-DRX operation, assuming that the maintained On-duration burst has ended.

A case may be considered in which the DRX structure is used for the purpose of transmitting and receiving traffic of a service with specific requirements. In this case, the BS may assume that the UE will perform the min-DRX operation at the starting position of the On-duration burst, determined according to Base-DRX configuration information. In addition, the BS may determine a maximum period in which the On-duration burst may be maintained based on the set maximum length of the On-duration burst. When the configuration information includes information such as an ODB-timer, the BS may assume that the UE will run the ODB-timer from the starting position of the On-duration burst and terminate the maintained On-duration burst based on the ending time of the ODB-timer. Alternatively, when the configuration information includes information such as a Max-OD, the BS may assume that the UE will cumulatively calculate the number of On-durations generated from the starting position of the On-duration burst, and when the calculated value is equal to the Max-OD value, terminate the maintained On-duration burst.

When the DRX structure is used for the purpose of transmitting and receiving traffic of a service with specific requirements, an On-duration may be in the form of a window or a mask. In this case, when the configuration information includes information such as an ODB-timer, the BS may assume that the UE will run the ODB-timer from the starting position of the On-duration burst and terminate the maintained On-duration burst based on the ending time of the ODB-timer. Alternatively, when the configuration information includes information such as a Max-OD, the BS may assume that the UE will cumulatively calculate the number of windows (or masks) generated from the starting position of the On-duration burst, and when the calculated value is equal to the Max-OD value, terminate the maintained On-duration burst.

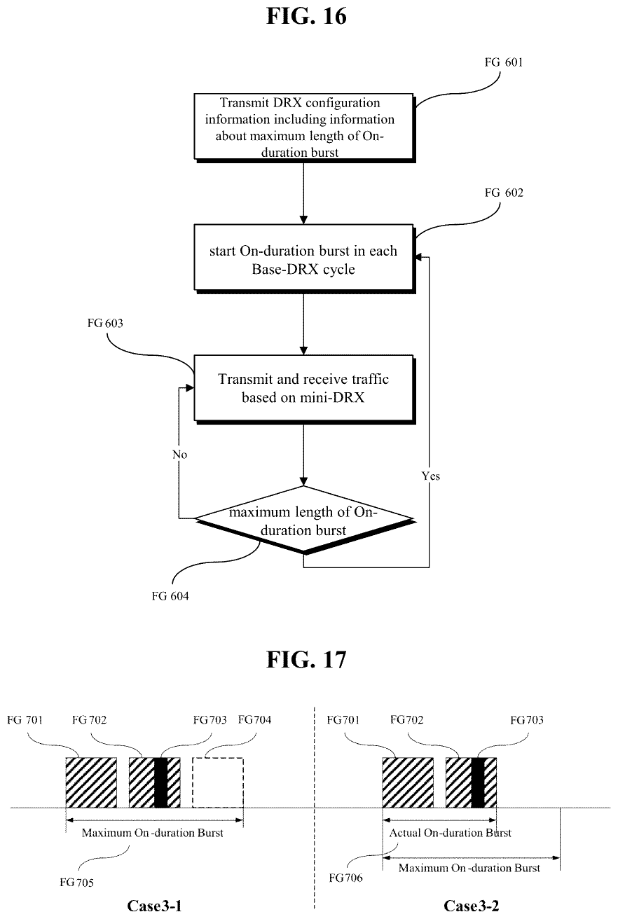

FIG. 16 illustrates an exemplary BS operation.

Referring to FIG. 16, the BS may generate DRX configuration information including information about a maximum length of an On-duration burst and transmit it (FG601). The information about the maximum length of the On-duration burst may be timer information about the On-duration burst or information about a maximum number of On-durations that may be generated in the On-duration burst. For example, the configuration information may be transmitted through a higher layer signal (e.g. an SIB or RRC signaling).

Then, the BS may expect that the UE will start the On-duration burst at the starting position of the On-duration burst, determined in each Base-DRX cycle, based on the transmitted DRX configuration information and perform a related operation (FG602).

The BS may expect that one or more On-durations may be generated in the On-duration burst, and may perform the mini-DRX operation at the positions of the On-durations (FG503). For example, when the BS needs to transmit DL traffic or receive UL traffic, the BS may indicate scheduling by transmitting a PDCCH at the positions of the On-durations.

The BS may use the information about the maximum length of the On-duration burst to determine whether the On-duration burst of the UE is maintained (FG604). When the On-duration burst is maintained, the BS may assume that the UE maintains the mini-DRX operation (FG603), and when the On-duration burst ends (FG604), the BS may assume that the UE will terminate the mini-DRX operation and perform an operation based on the next Base-DRX (FG602). As a criterion for determining whether the On-duration burst is maintained, when a timer value is set, a time when the timer ends may be set, or when a maximum number of On-durations is set, the number of On-durations generated in the On-duration burst may be set.

According to Proposal 2, unnecessary power consumption of the UE may be prevented by limiting the length of an On-duration burst. Particularly, when it is assumed that there is a separate condition for terminating the On-duration burst, it is advantageous in that a function of terminating the On-duration burst without continuing it is provided even when the separate condition does not occur or the UE misses the condition. Further, it is advantageous in eliminating ambiguity even without signaling in real time between the BS and the UE by proposing a method of calculating the maximum length of an On-duration burst using a parameter that the BS and the UE are capable of commonly calculating, such as a time value or the number of On-durations.

### [Proposal 3] Determining Operation for On-Duration Burst According to Specific Condition

When an On-duration burst is configured, a method of determining an operation related to the On-duration burst according to a specific condition is proposed.

The specific condition may be determined as reception of a specific signal or channel at the UE. For example, it may be determined as detection of a PDCCH for a specific purpose (hereinafter, referred to as a Target-PDCCH). In a characteristic example, the Target-PDCCH may be for transmitting and receiving a DCI format that schedules traffic. For convenience of description, the proposal is described in the context of whether the UE detects the Target-PDCCH. However, the disclosure may also be applied to other signals or channels.

The operation related to the On-duration burst may be whether to maintain the mini-DRX operation at the UE. For example, the mini-DRX operation may be determined to be maintained until the UE receives the Target-PDCCH in the On-duration burst, and when the UE successfully detects the Target-PDCCH, the mini-DRX operation may be terminated.

Alternatively, the operation related to the On-duration burst may be whether an On-duration is generated and assumed in the On-duration burst. For example, when the UE fails to receive the Target-PDCCH until a specific On-duration position in the On-duration burst, the next On-duration may be generated and assumed, and when the UE successfully detects the Target-PDCCH at the specific On-duration position, the subsequent On-duration(s) may be generated or assumed no longer in the same On-duration burst.

Alternatively, the operation related to the On-duration burst may be whether to maintain the On-duration burst. For example, the On-duration burst may be maintained until the UE receives the Target-PDCCH in the On-duration burst, and when the UE succeeds in detecting the Target-PDCCH, the On-duration burst may be terminated before the maximum length condition is satisfied.

The above-described operations related to the On-duration burst are methods which may be implemented to achieve the same purpose, and the purpose may be to prevent unnecessary power consumption that may occur when the UE maintains mini-DRX, continues to monitor the next On-duration, and/or continues to maintain necessary operations in the On-duration burst, even after completion of transmission and reception of necessary control/traffic information for the UE expecting transmission and reception of the Target-PDCCH in the On-duration burst. For the convenience of description, the operations related to the On-duration burst, which are performed after detection of the Target-PDCCH, are described as ODB-state transition.

To ensure a period in which the BS and the UE complete the related operations for which the Target-PDCCH is, a timing at which the ODB-state transition is performed may be determined to be after a subsequent operation (e.g., termination of related timers, or termination of an active time to which the Target-PDCCH belongs) related to the detection of the Target-PDCCH is completed.

FIG. 17 illustrates an example of Proposal 3. FIG. 17 is only an example, to which the disclosure is not limited.

Referring to FIG. 17, Case 3-1 illustrates a method of determining whether to maintain mini-DRX and generate/assume an On-duration depending on whether the UE receives a Target-PDCCH. When the UE fails to detect the Target-PDCCH at the position of an On-duration generated after an On-duration burst starts (FG701), the UE determines to maintain mini-DRX or generate the next On-duration, and when the UE succeeds in receiving the Target-PDCCH FG703 at the position FG702 of a specific On-duration position, the UE terminates mini-DRX or discontinues to generate/assume the next On-duration (FG704).

Case 3-2 illustrates a method of determining whether to maintain an On-duration burst depending on whether the UE receives a Target-PDCCH. When the UE fails to detect the Target-PDCCH at the position of an On-duration generated after an On-duration burst starts (FG701), the UE determines to maintain mini-DRX or generate the next On-duration, and when the UE succeeds in receiving the Target-PDCCH FG703 at the position FG702 of a specific On-duration, the UE terminates the On-duration burst early (FG706).

For example, a situation is considered in which the UE receives information (e.g., a search space configuration, a DCI format, and a field configuration) about the Target-PDCCH from the BS, and monitors the Target-PDCCH in an On-duration burst or On-duration(s) configured in the On-duration burst, based on the information. The information may be provided through a higher layer signal (e.g., an SIB or RRC signaling). One or more types of Target-PDCCHs that the UE monitors may be configured.

The UE may expect that an On-duration burst will start in each Base-DRX cycle, and assume that On-duration(s) in which the mini-DRX operation is performed may be generated in a period in which the On-duration burst is maintained.

The UE may monitor the Target-PDCCH in the On-durations generated in the period in which the On-duration burst is maintained.

When the UE fails to receive the Target-PDCCH, it maintains a previous state, and when the UE receives the Target-PDCCH, it may perform ODB-state transition.

A case may be considered in which the DRX structure is used for the purpose of transmitting and receiving traffic of a service with specific requirements. In this case, the UE may assume that the mini-DRX operation is performed at the starting position of an On-duration burst, determined according to Base-DRX configuration information. In addition, the UE may receive configuration information for PDCCH monitoring in an On-duration (or a period distinguished by a window or mask) from the BS, and may expect to receive it. When the UE receives a specific PDCCH (e.g., a PDCCH carrying scheduling DCI) in the On-duration burst, the UE may terminate the mini-DRX operation or assume that the on-going On-duration burst will end.

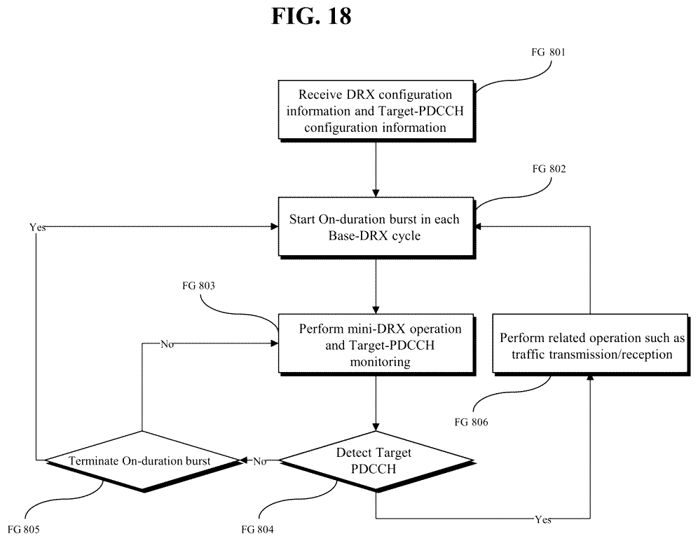

FIG. 18 illustrates an exemplary UE operation.

Referring to FIG. 18, the UE may receive Target-PDCCH configuration information and DRX configuration information (FG801). The Target-PDCCH configuration information may include information (e.g., a search space configuration, a DCI format, and a field configuration) required for the UE to receive a PDCCH. For example, the configuration information may be received through a higher layer signal (e.g., an SIB or RRC signaling).

The UE may then expect that an On-duration burst will start at the starting time of the On-duration burst, determined in each Base-DRX cycle, based on the received DRX configuration information, and perform a related operation (FG802).

The UE may expect that one or more On-durations may be generated in the On-duration burst, and perform the mini-DRX operation at the positions of the On-durations (FG803). For example, the mini-DRX operation may include PDCCH monitoring at the positions of the On-durations generated in the On-duration burst.

When the UE fails to detect a Target-PDCCH in an On-duration (FG804) and when the On-duration burst is maintained (FG805), the UE may maintain the mini-DRX operation and continue to perform PDCCH monitoring at the position of an On-duration. When the On-duration burst ends (FG805), the UE may terminate the mini-DRX operation and perform an operation based on the next Base-DRX (FG802).

When the UE detects the Target-PDCCH in the On-duration (FG804), the UE may perform an operation accompanying the Target-PDCCH (FG806). Further, the UE may terminate the mini-DRX operation and perform an operation based on the next Base-DRX after the accompanying operation is completed (FG802).

A situation is considered in which the BS provides information about a Target-PDCCH (e.g., a search space configuration, a DCI format, and a field configuration) to the UE, and transmits the Target-PDCCH based on the information, when needed. The information may be provided through a higher layer signal (e.g., an SIB or RRC signaling). The BS may configure one or more types of Target-PDCCHs for the UE.

The BS may assume that the UE will perform the mini-DRX operation in an On-duration burst generated in each Base-DRX cycle. When the BS has not transmitted the Target-PDCCH after the On-duration burst starts, or when the BS has transmitted the Target-PDCCH but has failed to receive a required feedback (e.g., a HARQ-ACK or a PUSCH) from the UE, the BS may assume that the UE has not performed the ODB-state transition.

When the BS transmits the Target-PDCCH in the On-duration burst and may assume that the UE receives it, the BS may assume that the UE will perform the ODB-state transition.

A case may be considered in which the DRX structure is used for the purpose of transmitting and receiving traffic of a service with specific requirements. The BS may assume that the UE will perform the mini-DRX operation at the starting position of an On-duration burst, determined according to Base-DRX configuration information. Further, the BS may generate configuration information for PDCCH monitoring in an On-duration (or a period distinguished by a window or mask), provide the configuration information to the UE, and expect the UE to perform a reception operation based on the configuration information. In the presence of traffic that the BS wants to schedule, the BS may transmit a specific PDCCH (e.g., a PDCCH carrying scheduling DCI) in an On-duration generated in the On-duration burst, perform an operation accompanying the transmission, and then assume that the UE will terminate the mini-DRX operation or the on-going On-duration burst.

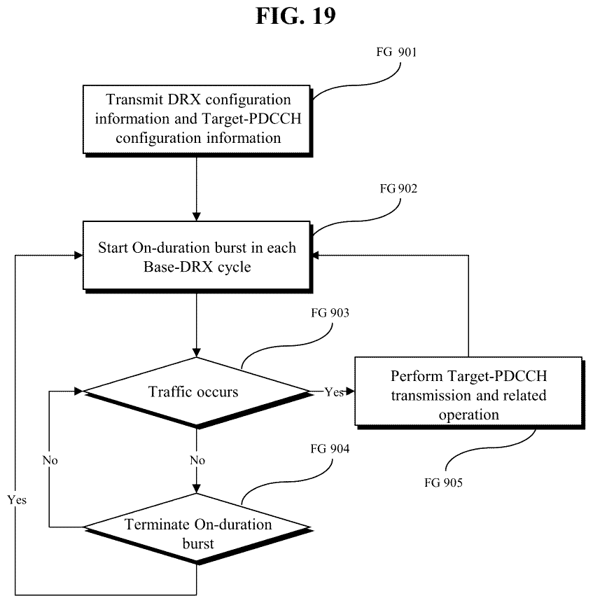

FIG. 19 illustrates an exemplary BS operation.

The BS may generate and transmit Target-PDCCH configuration information and DRX configuration information (FG901). The Target-PDCCH configuration information may include information (e.g., a search space configuration, a DCI format, and a field configuration) that the BS needs to generate and transmit a PDCCH. For example, the configuration information may be transmitted through a higher layer signal (e.g., an SIB or RRC signaling).

The BS may then perform a related operation, assuming that the UE will expect an On-duration burst to start at a starting position of the On-duration burst, determined in each Base-DRX cycle, based on the transmitted DRX configuration information (FG902).

In the absence of traffic that the BS wants to schedule (FG903) and the On-duration burst has not ended (FG904), the BS may expect that the UE will maintain a mini-DRX operation. When the On-duration burst ends (FG904), the BS may assume that the UE will terminate the mini-DRX operation and perform an operation based on the next Base-DRX (FG902).

Upon generation of traffic that the BS wants to schedule (FG903), the BS may transmit a Target-PDCCH and perform an accompanying transmission and reception operation.

Referring again to FIG. 18, the UE may expect that one or more On-durations may be generated in the On-duration burst, and may perform the mini-DRX operation at the positions of the On-durations (FG803). For example, the mini-DRX operation may include PDCCH monitoring at the positions of the On-durations generated in the On-duration burst.

When the UE fails to detect the Target-PDCCH in an On-duration (FG804) and the On-duration burst is maintained (FG805), the UE may maintain the mini-DRX operation and continue to perform PDCCH monitoring at the position of an On-duration. When the On-duration burst ends (FG805), the UE may terminate the mini-DRX operation and perform an operation based on the next Base-DRX (FG802).

Referring to FIG. 19 again, upon detection of the Target-PDCCH in an On-duration (FG903), the UE may perform an operation accompanying the Target-PDCCH (FG905). After the BS completes the transmission/reception procedure, the BS may assume that the UE will perform the operation based on the next Base-DRX after the mini-DRX operation and the accompanying operation are completed (FG902).

According to Proposal 3, when the characteristics of a generation and transmission/reception timing of traffic, such as XR, may be affected by jitter, the length of an On-duration burst (or On-duration) that the BS configures for the UE may be increased, as described before. However, the structure in which the On-duration burst and the mini-DRX operation are continuously maintained even after transmission/reception of required traffic in a specific On-duration burst is completed may be disadvantageous for power saving of the UE. When the proposal is used, even if the length of the On-duration burst is set large, the On-duration burst or the mini-DRX operation may be terminated early when the transmission/reception of the traffic required for the UE is completed. Accordingly, power saving efficiency may be ensured, while the effect of reducing a scheduling delay for the traffic is maintained.

### [Proposal 4] Determining Position of Each On-Duration in On-Duration Burst

When an On-duration burst is configured, a method of determining the positions of On-durations generated in an On-duration burst is proposed. While the proposal is described below in the context of a structure in which one or more On-durations are generated in an On-duration burst, the proposal may be applied to other methods of achieving similar purposes, such as configuring one or more windows in which a UE monitors a PDCCH in an On-duration burst (or On-duration) or dividing a period in which PDCCH monitoring is available through masking/gap settings. Specifically, the positions of On-durations generated in an On-duration burst may be determined using one of the following options.
Option 4-1: A method of determining the starting position of an On-duration in each mini-DRX cycle
Option 4-2: A method of setting a gap between consecutive On-durations
Option 4-3: A method of determining the starting position of the next On-duration by concatenating it to the ending time of the previous On-duration

Option 4-1 is a method of generating the position of an On-duration periodically (or according to a predetermined pattern) in an On-duration burst. To support Option 4-1, the BS may determine mini-DRX-related parameters and provide them to the UE. The parameters related to mini-DRX may include, for example, a periodicity (hereinafter, referred to a mini-DRX cycle) of generating an On-duration in an On-duration burst and a position (hereinafter, referred to as a mini-DRX offset) at which the first On-duration for the mini-DRX operation is generated from the starting time of the On-duration burst.

Option 4-2 is a method of determining a relative position between On-durations in an On-duration burst, in the form of a gap (hereinafter, referred to as a mini-gap). To support Option 4-2, the BS may determine parameters for determining the relative position between the On-durations and provide them to the UE. The parameters for determining the relative position between the On-durations include, for example, the size of the gap configured between the On-durations generated in the On-duration burst and a position (hereinafter, referred to as a mini-DRX offset) at which the first On-duration for the mini-DRX operation is generated from the starting time of the On-duration burst.

Option 4-3 may be a method of generating On-durations by concatenating them in an On-duration burst. Specifically, when the ending time of an n^{th} (n>0) On-duration in the On-duration burst is an m^{th} time unit (e.g., OFDM symbol or slot), the starting time of an (n+1)^{th} On-duration may be set to an (m+1)^{th} time unit.

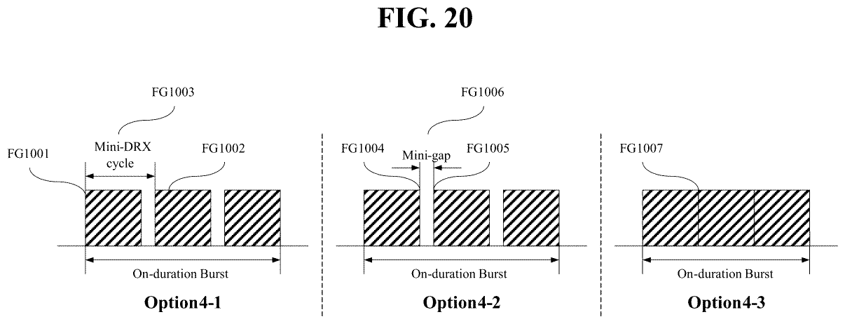

FIG. 20 illustrates examples related to Proposal 4. FIG. 20 is only an example, to which the disclosure is not limited.

In an example of Option 4-1, the position of each On-duration occurs in each mini-DRX cycle FG1003 in an On-duration burst. The starting time FG1001 of a first On-duration and the starting time FG1002 of a second On-duration are spaced apart from each other by the mini-DRX cycle.

In an example of Option 4-2, the position of each On-duration in an On-duration burst is determined by a mini-gap FG1006. The mini-gap is formed between the ending time FG1004 of a first On-duration and the starting time FG1005 of a second On-duration.

In an example of Option 4-3, On-durations are contiguously generated in an On-duration burst. The ending time of a first On-duration and the starting time of a second On-duration are at the same position FG1007.

A situation is considered in which the UE receives mini-DRX information from the BS and determines a position at which an On-duration is generated in an On-duration burst based on the mini-DRX information. The mini-DRX information may include, for example, information such as a mini-DRX cycle or information such as a mini-gap. The information may be provided through a higher layer signal (e.g., an SIB or RRC signaling).

The UE may expect that an On-duration burst will start in each Base-DRX cycle, and assume that On-duration(s) in which the mini-DRX operation is performed may be generated in a period during which the started On-duration burst is maintained.

The UE may estimate the position(s) at which the On-duration(s) are generated in the On-duration burst, based on the received mini-DRX configuration information.

A case may be considered in which the DRX structure is used for the purpose of transmitting and receiving traffic of a service with specific requirements. In this case, the UE may assume that the mini-DRX operation is performed at the starting position of the On-duration burst, determined according to Base-DRX configuration information. Further, the UE may estimate the position(s) of the On-duration(s) that may be assumed in the On-duration burst, based on the configuration information.

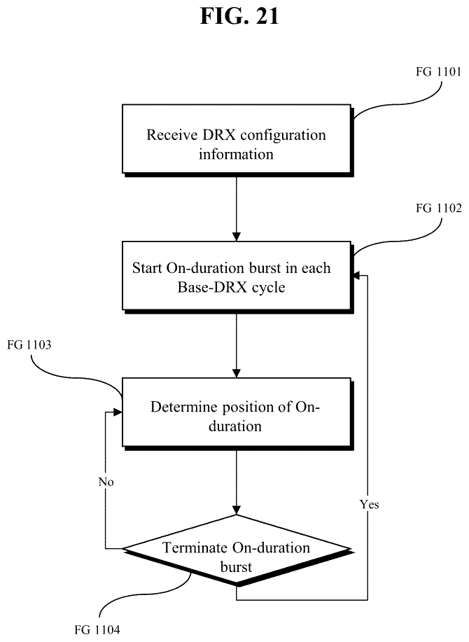

FIG. 21 illustrates an exemplary UE operation.

Referring to FIG. 21, the UE may receive DRX configuration information including On-duration position configuration information (FG1101). The On-duration position configuration information may be, for example, information for configuring a mini-DRX cycle, information about a gap between On-durations, or separate configuration information for specifying a relative position between On-durations may not be provided. For example, the configuration information may be received through a higher layer signal (e.g. an SIB or RRC signaling).

The UE may then expect an On-duration burst to start at the starting time of the On-duration burst, determined in each Base-DRX cycle, based on the received DRX configuration information, and perform a related operation (FG1102).

The UE may expect one or more On-durations to be generated in the On-duration burst, and determine positions at which the On-durations are generated based on the received On-duration position configuration information (FG1103). For example, the position of a first On-duration may be determined as a relative position with respect to the starting position of the On-duration burst, and the positions of subsequent On-durations may be determined by referring to their immediate previous On-durations.

The UE may determine the positions of the On-durations by repeating the above operation until the ending time of the On-duration burst, and when the On-duration burst has ended (FG1104), the UE may terminate the mini-DRX operation and perform an operation based on the next Base-DRX (FG1102).

For example, a situation may be considered in which the BS determines mini-DRX information and provides it to the UE, and the UE determines positions at which On-durations are generated in an On-duration burst based on the mini-DRX information. The mini-DRX information may include, for example, information such as a mini-DRX cycle or information such as a mini-gap. The information may be provided through a higher layer signal (e.g. an SIB or RRC signaling).

The BS may assume that the UE will perform the mini-DRX operation in an On-duration burst generated in each Base-DRX cycle. The BS may assume that the position(s) of On-duration(s) which the UE expects to be generated in the On-duration-burst will be determined based on the mini-DRX information configured and provided to the UE.

A case may be considered in which the DRX structure is used for the purpose of transmitting and receiving traffic of a service with specific requirements. The BS may assume that the UE will perform the mini-DRX operation at the starting position of the On-duration burst, determined according to Base-DRX configuration information. In addition, the BS may assume that the UE will determine the position(s) of the On-duration(s) assumable in the On-duration burst based on the configuration information.

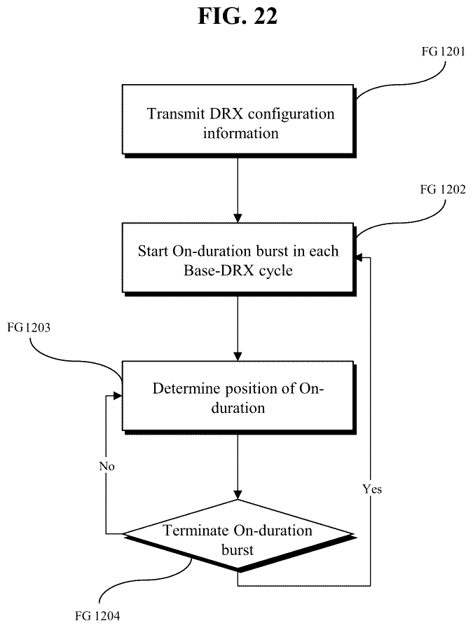

FIG. 22 illustrates an exemplary BS operation.

Referring to FIG. 22, the BS may determine DRX configuration information including On-duration position configuration information and provide it to the UE (FG1201). The On-duration position configuration information may be, for example, information for setting a mini-DRX cycle, or information about a gap between On-durations, or separate configuration information for specifying a relative location between On-durations may not be provided. For example, the configuration information may be provided through a higher layer signal (e.g., an SIB or RRC signaling).

The BS may then assume that the UE will expect the On-duration burst to start at the starting time of the On-duration burst, determined in each Base-DRX cycle, based on the transmitted DRX configuration information, and perform a related operation (FG1202).

The BS may assume positions at which the UE may expect On-durations to be generated in the On-duration burst, based on the transmitted On-duration position configuration information (FG1203). For example, the BS may assume that the position of a first On-duration that the UE may assume may be determined as a relative position with respect to the starting position of the On-duration burst, and the UE may determine the positions of subsequent On-durations by referring to their immediate previous On-durations.

The BS may assume that the UE will determine the positions of the On-durations by repeating the above operation until the ending time of the On-duration burst, and when the On-duration burst has ended (FG1204), the BS may expect the UE to terminate the mini-DRX operation and perform an operation based on the next Base-DRX (FG1202).

When Option 4-1 is used, it may be advantageous in obtaining the power saving effect for the UE according to traffic characteristics, because a period between On-durations, in which the UE may temporarily discontinue PDCCH monitoring, may be ensured depending on a configuration from the BS. Further, since Option 4-1 follows the DRX operation structure of the UE, when an On-duration burst takes the form of a window for specifying a period for performing the mini-DRX operation, it may have the advantage of reusing the existing operation method of the UE in that it may be implemented by using the existing DRX structure.

When Option 4-2 is used, it may be advantageous in obtaining the power saving effect for the UE according to traffic characteristics, because it may guarantee a period between On-durations, in which the UE may temporarily discontinue PDCCH monitoring, according to a configuration from the BS. Further, when a mini-gap is configured such that a requirement value based on a UE capability or a special operation is reused, a signaling overhead for specifying positions at which On-durations are generated is not separately generated.

When Option 4-3 is used, a period in which the UE temporarily discontinues PDCCH monitoring is not generated in an On-duration burst even without separate signaling overhead. Accordingly, when traffic requiring low latency is used, a gap-incurring delay may be reduced, and for the same number of On-durations, the total length of the On-duration burst may be reduced.

### [Proposal 5] Individual Control of On-Durations in On-Duration Burst

Methods of obtaining an additional power saving effect and scheduling flexibility by fine control of On-durations generated in an On-duration burst at a BS are proposed.

### [Proposal 5-1] Setting Length of On-Duration

When a plurality of On-durations are configured in an On-duration burst, the length of each On-duration may be set individually, and for example, each On-duration may have a different length. For example, the length of a first On-duration in the On-duration burst may be set to have a larger value than the lengths of the other subsequent On-durations. Proposal 5-1 may be used to ensure at least operations (e.g. CSI reporting/SRS transmission) other than PDCCH monitoring performed by the UE in On-durations, through the first On-duration, when a method of early terminating mini-DRX or an On-duration burst is used, as in Proposal 3. The above example is only an example, and those skilled in the art will understand that the proposal of the disclosure may be generally applied even when the length of an On-duration of a different structure is set.

When Proposal 5-1 is used, the length of each On-duration (or an On-duration set including one or more On-durations) may be a fixed value or a relative ratio set by the standard, or may be a value set and provided by the BS. When the value is set by the BS, the above information may be provided by the BS to the UE through a higher layer signal (e.g. an SIB or RRC signaling). Alternatively, a method may be used in which the BS dynamically or semi-statically selects a length for the UE through an L1 layer (e.g. DCI or a reference signal) or an L2 layer (e.g. a MAC CE).

### [Proposal 5-2] Signaling Indicating Whether On-Duration is Generated

When a plurality of On-durations are configured in an On-duration burst, signaling indicating whether each On-duration is generated may be used. For example, the signaling may be signaling that the BS dynamically or semi-statically transmits to the UE through the L1 layer (e.g. DCI or a reference signal) or the L2 layer (e.g. a MAC CE). For example, the BS may indicate to the UE through L1/L2 signaling whether the UE may assume generation of a next On-duration (or On-durations), whether to maintain mini-DRX, or whether to maintain an On-duration burst. This may have a beneficial effect in increasing the scheduling flexibility of the BS and adaptively controlling the power saving efficiency of the UE, as the BS dynamically or semi-statically controls operations of the UE related to the On-durations in consideration of a traffic situation.

When Proposal 5-2 is used, the BS may provide the UE with related information through a higher layer signal (e.g. an SIB or RRC signaling) to configure the L1 or L2 signal that controls generation of each On-duration.

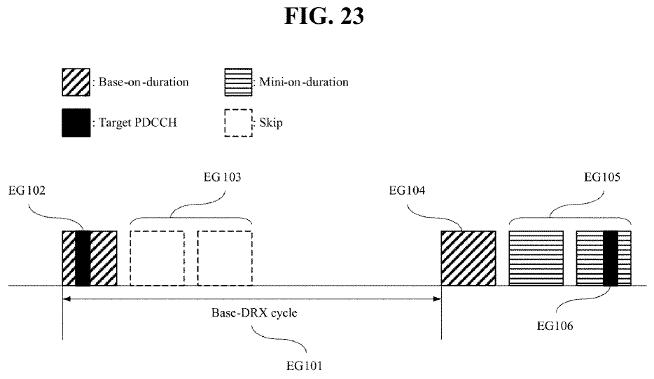

A specific example will be described with reference to FIG. 23. The UE receives DRX configuration information (Base-DRX) for a basic DRX operation from the BS, and the configuration information may include a Base-DRX cycle, information about Base-DRX On-durations, a timer for setting an active time, and so on. Further, the UE receives DRX configuration information (mini-DRX) for a short DRX operation from the BS, and the configuration information may include a mini-DRX cycle, information about mini-DRX On-durations, a timer for setting an active time, and so on. The configuration information for Base-DRX and mini-DRX may be information that the BS provides to the UE through a higher layer signal (e.g. an SIB or RRC signal). Based on the configured information, the BS and the UE may assume that Base-On-durations will be generated in each Base-DRX cycle (EG101). When the BS transmits a Target-PDCCH at the position of a Base-On-duration and the UE succeeds in detecting it (EG102), the BS and the UE perform necessary operations while the timer is running in the Base-On-duration in which the Target-PDCCH is transmitted and received, and assume that a mini-DRX period is not activated (EG103), and the UE may maintain the DRX state until the position of the next Base-On-duration determined based on the Base-DRX cycle. When the BS did not transmit the Target-PDCCH at the position of the Base-On-duration or transmitted it but the UE failed to detect it (EG104), the mini-DRX period may be activated (EG105), and the UE may monitor the Target-PDCCH at the position(s) of mini-On-duration(s) determined based on the mini-DRX cycle, and the BS may expect this and transmit the Target-PDCCH. When a specific condition is satisfied, for example, when the Target-PDCCH is detected in a specific mini-On-duration or a maximum period in which the mini-DRX may be maintained has expired, the UE may terminate the mini-DRX operation (EG106). When this example is applied to NR, Base-DRX may be a concept corresponding to the long DRX defined in the standards, and mini-DRX may be a concept corresponding to the short DRX defined in the standards. However, the rule for switching between the long DRX and the short DRX may be configured not to follow the legacy standards, and the method described in the example may be applied, which may be available only when configured by the BS.

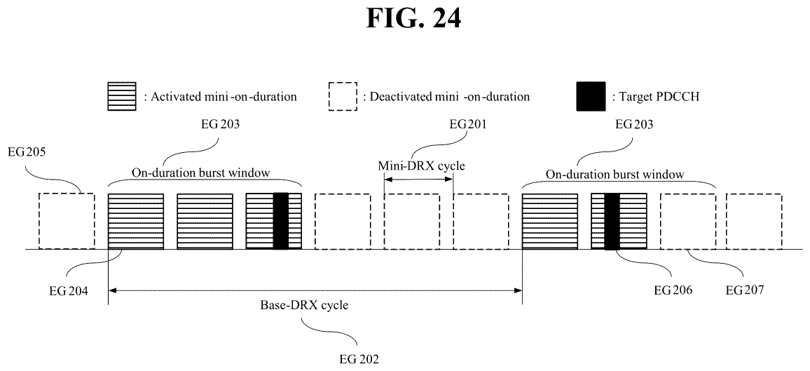

A specific example will be described with reference to FIG. 24. The UE may receive DRX configuration information (mini-DRX) for a short DRX operation from the BS, and the configuration information may include a mini-DRX cycle, mini-DRX On-duration information, a timer for setting an active time, and so on. Further, the UE may receive configuration information (Active-DRX) from the BS to determine a period in which mini-DRX is actually activated, and the configuration information may include a cycle (Base-DRX cycle) in which the period in which the mini-DRX is activated occurs, a maximum length of the period in which the mini-DRX is activated, and so on. The configuration information for mini-DRX and Active-DRX may be information that the BS provides to the UE through a higher layer signal (e.g. an SIB or RRC signal). Based on the configured information, the BS and the UE may assume that an On-duration candidate will be generated in each mini-DRX cycle EG201, and also assume that an activation period EG203 of the mini-DRX operation will occur in each Base-DRX cycle EG202. The BS and the UE may assume that On-duration candidates belonging to the activation period of the mini-DRX operation are activated (EG204) and expect to transmit or receive a Target-PDCCH in the activated On-durations. On the contrary, the BS and the UE may assume that On-duration candidates not included in the activation period of the mini-DRX operation are not activated (EG205) and expect not to transmit or receive the Target-PDCCH at deactivated positions. When the BS does not satisfy a specific condition at the position of an activated On-duration, for example, when the Target-PDCCH is not transmitted or is transmitted but the UE fails to detect it, the mini-DRX operation may be maintained. When the BS satisfies the specific condition, for example, when the UE receives the transmitted Target-PDCCH (EG206), the UE may assume that the remaining On-duration candidates in the current Base-DRX cycle will be deactivated (EG207).

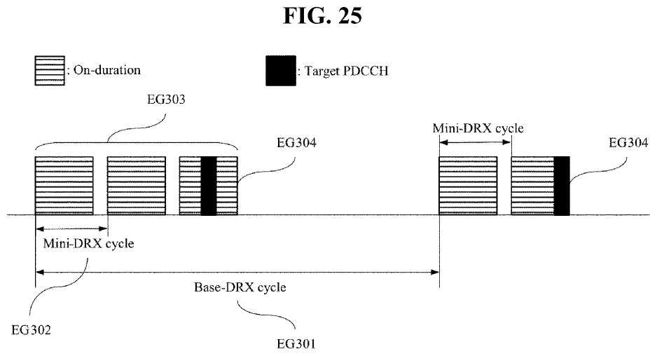

A specific example will be described with reference to FIG. 25. The UE receives DRX configuration information (Base-DRX) for a basic DRX operation from the BS. The configuration information may include a Base-DRX cycle and offset information for determining the starting position of the Base-DRX cycle. Further, the UE receives DRX configuration information (mini-DRX) for a short DRX operation from the BS, and the configuration information may include a mini-DRX cycle, min-DRX On-duration information, and a timer for setting an active time. The configuration information for Base-DRX and mini-DRX may be information that the BS provides to the UE through a higher layer signal (e.g. an SIB or RRC signal). Based on the configured information, the BS and the UE may assume that the mini-DRX operation starts in each Base-DRX cycle (EG301). In this case, the mini-DRX operation means that On-durations are generated every mini-DRX cycle EG302 from the starting position of the mini-DRX, determined based on the Base-DRX cycle (EG303). When the BS does not transmit a Target-PDCCH in a specific On-duration or transmits it but the UE does not receive it, the UE may assume that the next On-duration will be generated based on the mini-DRX cycle while maintaining the mini-DRX operation. On the contrary, when the BS transmits the Target-PDCCH in the specific On-duration and the UE successfully receives it, the UE may assume that no additional On-durations will be generated in the Base-DRX cycle, and the BS may consider this (EG304).

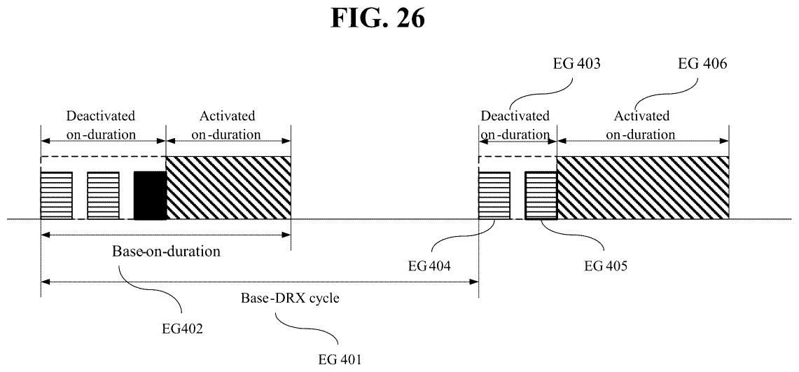

A specific example will be described with reference to FIG. 26. The UE may receive DRX configuration information (Base-DRX) for a basic DRX operation from the BS, and the configuration information may include a Base-DRX cycle, Base-DRX On-duration information, a timer for setting an active time, and so on. Further, the UE receives DRX configuration information (mini-DRX) for a short DRX operation from the BS, and the configuration information may include a mini-DRX cycle, mini-DRX window (or duration) information, and so on. The configuration information for Base-DRX and mini-DRX may be information that the BS provides to the UE through a higher layer signal (e.g. an SIB or RRC signal). Based on the configured information, the BS and the UE may assume that a Base-On-duration EG402 will be generated in each Base-DRX cycle EG401. In this case, after the Base-On-duration starts, the BS and the UE may assume that the Base-On-duration will not be activated until transmission and reception of a Target-PDCCH is performed (EG403). The BS and the UE may assume that the transmission of the Target-PDCCH from the BS and the reception of the Target-PDCCH at the UE may be performed in a mini-On-duration EG404 generated in each mini-DRX cycle in a period in which the Base-On-duration is not activated, based on the configuration information. When the UE fails to receive the Target-PDCCH in the mini-On-duration, the deactivation state of the Base-On-duration may be maintained (EG403). When the BS transmits the Target-PDCCH in the mini-On-duration and the UE receives it (EG405), the BS and the UE may assume that the mini-DRX operation is discontinued and the Base-On-duration is activated (EG406).

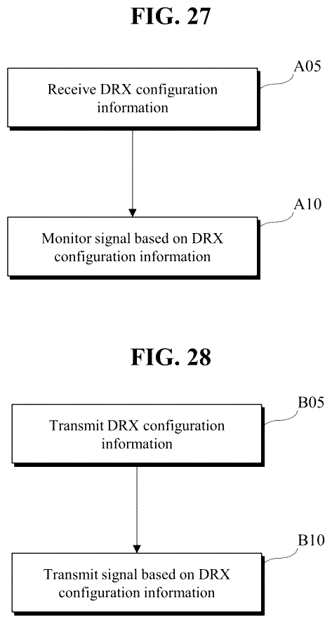

FIG. 27 is a flowchart illustrating signal reception at a UE according to an embodiment. FIG. 27 may be understood as an implementation example of at least some of the above-described Proposal 1 to Proposal 5, and the descriptions of Proposal 1 to Proposal 5 may be referred to for FIG. 27.

The UE may receive DRX configuration information including information about a DRX cycle (A05).

The UE may monitor a PDCCH based on the DRX configuration information (A10).

Each On-duration set including a plurality of On-durations spaced apart from each other on a time axis may be configured in each DRX cycle. The UE may monitor the PDCCH based on the plurality of On-durations included in each On-duration set. Based on the PDCCH being detected in any one of the plurality of On-durations as a result of monitoring the PDCCH, the UE may determine that a subsequent On-duration will not occur until a start of a next DRX cycle.

At least one of first information about a maximum time duration in which each On-duration set is maintained to be valid from a start of each On-duration set or second information about a maximum number of valid On-durations included in each On-duration set may be configured for the UE. The DRX configuration information may include at least one of the first information or the second information.

Based on the PDCCH being detected in an On-duration located before the maximum time duration or the maximum number of On-durations is reached, the On-duration set may be terminated early.

Data scheduled by the detected PDCCH may have a non-integer periodicity.

The DRX configuration information may include at least one of information about a gap between the plurality of On-durations or information about a position of a starting On-duration among the plurality of On-durations. The information about the gap between the plurality of On-durations may include a periodicity of the plurality of On-durations. The information about the position of the starting On-duration may include an offset between the start of the DRX cycle and the start of the starting On-duration.

A length of each On-duration may be individually configured in the same On-duration set.

FIG. 28 is a flowchart illustrating signal transmission from a BS according to an embodiment. FIG. 28 may be understood as an implementation example of at least some of the above-described Proposal 1 to Proposal 5, and the descriptions of Proposal 1 to Proposal 5 may be referred to for FIG. 28.

The BS may transmit DRX configuration information including information about a DRX cycle to a UE (B05).

The BS may transmit a PDCCH to the UE based on the DRX configuration information.

Each On-duration set including a plurality of On-durations spaced apart from each other on a time axis may be configured in each DRX cycle. The BS may transmit the PDCCH based on the plurality of On-durations included in each On-duration set. Based on the PDCCH being transmitted in any one of the plurality of On-durations, the BS may determine that a subsequent On-duration for the UE will not occur until a start of a next DRX cycle.

The BS may configure the UE with at least one of first information about a maximum time duration in which each On-duration set is maintained to be valid from a start of each On-duration set or second information about a maximum number of valid On-durations included in each On-duration set. The DRX configuration information may include at least one of the first information or the second information.

Based on the PDCCH being detected in an On-duration located before the maximum time duration or the maximum number of On-durations is reached, the On-duration set may be terminated early.

Data scheduled by the detected PDCCH may have a non-integer periodicity.

The DRX configuration information may include at least one of information about a gap between the plurality of On-durations or information about a position of a starting On-duration among the plurality of On-durations. The information about the gap between the plurality of On-durations may include a periodicity of the plurality of On-durations. The information about the position of the starting On-duration may include an offset between the start of the DRX cycle and the start of the starting On-duration.

A length of each On-duration may be individually set in the same On-duration set.

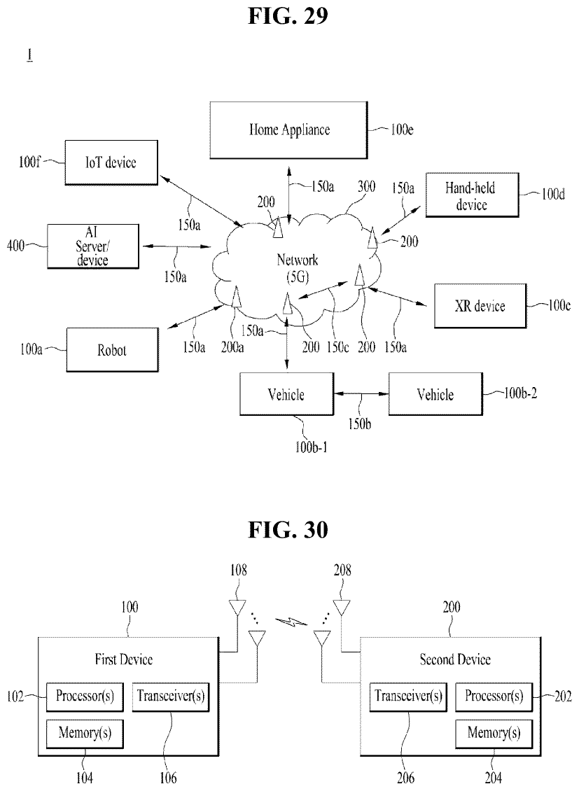

FIG. 29 illustrates a communication system 1 applied to the disclosure.

Referring to FIG. 29, a communication system 1 applied to the disclosure includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an eXtended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous driving vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g., Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g., relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the disclosure.

FIG. 30 illustrates wireless devices applicable to the disclosure.

Referring to FIG. 30, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 29.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In an embodiment of the disclosure, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In an embodiment of the disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

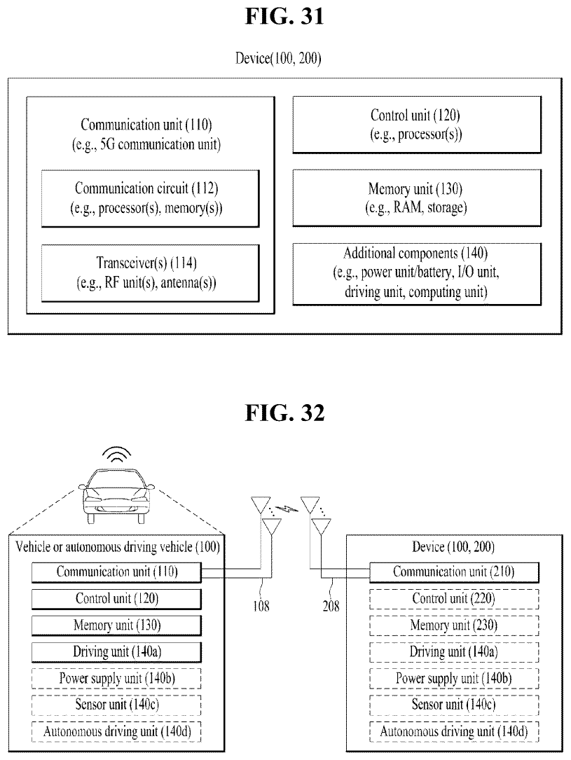

FIG. 31 illustrates another example of a wireless device applied to the disclosure. The wireless device may be implemented in various forms according to a use-case/service (refer to FIG. 29).

Referring to FIG. 31, wireless devices 100 and 200 may correspond to the wireless devices 100 and 200 of FIG. 30 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 30. For example, the transceiver(s) 114 may include the one or more transceivers 106 and 206 and/or the one or more antennas 108 and 208 of FIG. 30. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 29), the vehicles (100b-1 and 100b-2 of FIG. 29), the XR device (100c of FIG. 29), the hand-held device (100d of FIG. 29), the home appliance (100e of FIG. 29), the IoT device (100f of FIG. 29), a digital broadcast terminal, a hologram device, a public safety device, an MTC device, a medicine device, a fintech device (or a finance device), a security device, a climate/environment device, the AI server/device (400 of FIG. 29), the BSs (200 of FIG. 29), a network node, etc. The wireless device may be used in a mobile or fixed place according to a use-example/service.

In FIG. 31, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

FIG. 32 illustrates a vehicle or an autonomous driving vehicle applied to the disclosure. The vehicle or autonomous driving vehicle may be implemented by a mobile robot, a car, a train, a manned/unmanned Aerial Vehicle (AV), a ship, etc.

Referring to FIG. 32, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 31, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an Electronic Control Unit (ECU). The driving unit 140a may cause the vehicle or the autonomous driving vehicle 100 to drive on a road. The driving unit 140a may include an engine, a motor, a powertrain, a wheel, a brake, a steering device, etc. The power supply unit 140b may supply power to the vehicle or the autonomous driving vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the obtained data. The control unit 120 may control the driving unit 140a such that the vehicle or the autonomous driving vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly obtained data/information. The communication unit 110 may transfer information about a vehicle position, the autonomous driving path, and/or the driving plan to the external server. The external server may predict traffic information data using AI technology, etc., based on the information collected from vehicles or autonomous driving vehicles and provide the predicted traffic information data to the vehicles or the autonomous driving vehicles.

The above-described embodiments correspond to combinations of elements and features of the disclosure in prescribed forms. And, the respective elements or features may be considered as selective unless they are explicitly mentioned. Each of the elements or features may be implemented in a form failing to be combined with other elements or features. Moreover, it is able to implement an embodiment of the disclosure by combining elements and/or features together in part. A sequence of operations explained for each embodiment of the disclosure may be modified. Some configurations or features of one embodiment may be included in another embodiment or may be substituted for corresponding configurations or features of another embodiment. And, an embodiment may be configured by combining claims failing to have relation of explicit citation in the appended claims together or may be included as new claims by amendment after filing an application.

Those skilled in the art will appreciate that the disclosure may be carried out in other specific ways than those set forth herein without departing from the spirit and essential characteristics of the disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

### INDUSTRIAL APPLICABILITY

The disclosure is applicable to UEs, BSs, or other apparatuses in a wireless mobile communication system.

1. A method of receiving a signal by a user equipment (UE) in a wireless communication system, the method comprising:
receiving discontinuous reception (DRX) configuration information including information about a DRX cycle; and
monitoring a physical downlink control channel (PDCCH) based on the DRX configuration information,
wherein each On-duration set including a plurality of On-durations spaced apart from each other on a time axis is configured in each DRX cycle,
wherein the UE monitors the PDCCH based on the plurality of On-durations included in each On-duration set, and
wherein based on the PDCCH being detected in any one of the plurality of On-durations as a result of monitoring the PDCCH, the UE determines that no subsequent On-duration will occur until a start of a next DRX cycle.

2. The method according to claim 1, wherein the UE is configured with at least one of first information about a maximum time duration in which each On-duration set is maintained to be valid from a start of each On-duration set or second information about a maximum number of valid On-durations included in each On-duration set.

3. The method according to claim 2, wherein the DRX configuration information includes at least one of the first information or the second information.

4. The method according to claim 2, wherein based on the PDCCH being detected in an On-duration located before the maximum time duration or the maximum number of On-durations is reached, the On-duration set is early terminated.

5. The method according to claim 1, wherein data scheduled by the detected PDCCH has a non-integer periodicity.

6. The method according to claim 1, wherein the DRX configuration information includes at least one of information about a gap between the plurality of On-durations or information about a position of a starting On-duration among the plurality of On-durations.

7. The method according to claim 6, wherein the information about the gap between the plurality of On-durations includes a periodicity of the plurality of On-durations.

8. The method according to claim 6, wherein the information about the position of the starting On-duration includes an offset between a start of the DRX cycle and the start of the starting On-duration.

9. The method according to claim 1, wherein a length of each On-duration is individually configured in a same On-duration set.

10. A non-transitory processor-readable recoding medium recording a program for performing the method according to claim 1.

11. A device for wireless communication, the device comprising:
a memory configured to store instructions; and
a processor configured to perform operations by executing the instructions,
wherein the operations of the processor include:
receiving discontinuous reception (DRX) configuration information including information about a DRX cycle; and
monitoring a physical downlink control channel (PDCCH) based on the DRX configuration information,
wherein each On-duration set including a plurality of On-durations spaced apart from each other on a time axis is configured in each DRX cycle,
wherein the processor monitors the PDCCH based on the plurality of On-durations included in each On-duration set, and
wherein based on the PDCCH being detected in any one of the plurality of On-durations as a result of monitoring the PDCCH, the processor determines that no subsequent On-duration will occur until a start of a next DRX cycle.

12. The device according to claim 11, wherein the device is an application specific integrated circuit (ASIC) or a digital signal processing device.

13. The device according to claim 11, wherein the device is a user equipment (UE) operating in a 3^{rd} generation partnership project (3GPP)-based wireless communication system.

14. A method of transmitting a signal by a base station (BS) in a wireless communication system, the method comprising:
transmitting discontinuous reception (DRX) configuration information including information about a DRX cycle to a user equipment (UE); and
transmitting a physical downlink control channel (PDCCH) to the UE based on the DRX configuration information,
wherein each On-duration set including a plurality of On-durations spaced apart from each other on a time axis is configured in each DRX cycle,
wherein the BS transmits the PDCCH based on the plurality of On-durations included in each On-duration set, and
wherein based on the PDCCH being transmitted in any one of the plurality of On-durations, the BS determines that a subsequent On-duration for the UE will not occur until a start of a next DRX cycle.

15. A base station (BS) for wireless communication, the BS comprising:
a transceiver; and
a processor configured to transmit discontinuous reception (DRX) configuration information including information about a DRX cycle to a user equipment (UE) and to transmit a physical downlink control channel (PDCCH) to the UE based on the DRX configuration information, through the transceiver,
wherein each On-duration set including a plurality of On-durations spaced apart from each other on a time axis is configured in each DRX cycle,
wherein the processor transmits the PDCCH based on the plurality of On-durations included in each On-duration set, and
wherein based on the PDCCH being transmitted in any one of the plurality of On-durations, the processor determines that a subsequent On-duration for the UE will not occur until a start of a next DRX cycle.
